(19) United States
(12) Patent Application Publication
(10) Pub. No.: US 2025/0126216 A1
(43) Pub. Date: Apr. 17, 2025

(54) INFORMATION PROCESSING APPARATUS CONNECTABLE TO CUTTING MACHINE, CONTROL METHOD THEREFOR, STORAGE MEDIUM STORING CONTROL PROGRAM THEREFOR, AND INFORMATION PROCESSING SYSTEM

(71) Applicant: CANON KABUSHIKI KAISHA, Tokyo (JP)

(72) Inventors: ANNA HOSAKA, Ibaraki (JP); MASARU ONO, Ibaraki (JP)

(21) Appl. No.: 18/903,518

(22) Filed: Oct. 1, 2024

(30) Foreign Application Priority Data
Oct. 12, 2023 (JP) 2023-176843

(51) Int. Cl. H04N 1/00

(52) U.S. Cl. CPC H04N 1/00676; H04N 1/0044

(57) ABSTRACT

An information processing apparatus capable of executing operations from start of printing to completion of cutting with simple settings. The information processing apparatus is communicably connected to a cutting machine that cuts a sheet medium printed and processes information transmitted and received to and from the cutting machine. The information processing apparatus includes a memory device that stores a set of instructions and at least one processor that executes the set of instructions to obtain ability information about cutting ability of the cutting machine from the cutting machine, obtain a print job including print condition information about a print condition, and generate cut condition information related to a cut condition in cutting the medium with the cutting machine based on the ability information obtained and the print condition information included in the print job obtained. The medium is cut by the cutting machine based on the cut condition information generated.

### BACKGROUND OF THE INVENTION

### Field of the Invention

The present invention relates to an information processing apparatus connectable to a cutting machine, a control method therefor, a storage medium storing a control program therefor, and an information processing system.

### Description of the Related Art

Cutting machines for cutting media such as printed paper and cloth are known. For example, Japanese Patent Laid-Open Publication No. 2003-323272 (Counterpart of US20030202835 A1) discloses a printing apparatus including a printing unit that performs printing on a medium and a cutting unit that cuts the printed medium.

However, when cutting a printed medium, a printing apparatus having a printing unit only and a cutting machine having a cutting unit only are used more often than a printing apparatus having both a printing unit and a cutting unit. In the case where the printing apparatus and the cutting machine are used, a print setting for setting a print condition and a cut setting for setting a cut condition are respectively required, and as a result, there is a problem that setting operations become complicated and usability may be reduced.

### SUMMARY OF THE INVENTION

The present invention provides an information processing apparatus, an information processing system, a control method for the information processing apparatus, and a storage medium storing a control program for the information processing apparatus, which are capable of executing a series of operations from start of printing to completion of cutting with simple settings.

Accordingly, an aspect of the present invention provides an information processing apparatus communicably connected to a cutting machine that cuts a sheet medium printed and processing information transmitted and received to and from the cutting machine. The information processing apparatus includes a memory device that stores a set of instructions; and at least one processor that executes the set of instructions to: obtain ability information about cutting ability of the cutting machine from the cutting machine, obtain a print job including print condition information about a print condition, and generate cut condition information related to a cut condition in cutting the medium with the cutting machine based on the ability information obtained and the print condition information included in the print job obtained. The medium is cut by the cutting machine based on the cut condition information generated.

According to the present invention, the series of operations from the start of printing to the completion of cutting is executed with simple settings.

Further features of the present invention will become apparent from the following description of exemplary embodiments with reference to the attached drawings.

### BRIEF DESCRIPTION OF THE DRAWINGS

FIG. 1 is a block diagram showing a hardware configuration in a case where an information processing apparatus according to a first embodiment is applied to an image forming apparatus.

FIG. 2 is a block diagram showing a software configuration of the image forming apparatus.

FIG. 3 is a block diagram showing a hardware configuration of a cutting machine.

FIG. 4 is a block diagram showing a software configuration of the cutting machine.

FIG. 5 is a block diagram showing a hardware configuration of a communication terminal.

FIG. 6 is a block diagram showing a software configuration of the communication terminal.

FIG. 7 is a block diagram showing an information processing system.

FIG. 8 is a view showing an example of cut setting information (cutting condition information) that is generated by the image forming apparatus based on print setting information (print condition information).

FIGS. 9A to 9G are views showing examples of operation screens displayed on the image forming apparatus.

FIG. 10 is a view showing an example of an operation screen displayed by a print driver for the image forming apparatus operating on the communication terminal.

FIG. 11 is a flowchart showing an example of a process executed by a print-cut cooperation application.

FIG. 12 is a sequential chart showing an example of a process executed between the image forming apparatus, the cutting machine, and the print driver.

FIG. 13 is a sequential chart showing an example of a process executed between a user, the print driver, the image forming apparatus, and the cutting machine.

FIG. 14 is a view showing an example of cut instruction information.

FIGS. 15A to 15D are views showing examples of operation screens displayed on an image forming apparatus according to a second embodiment.

FIGS. 16A to 16C are views showing examples of operation screens displayed on the image forming apparatus in an online storage device connection setting in the print-cut cooperation application.

FIG. 17 is a flowchart showing an example of a process executed by the print-cut cooperation application.

FIG. 18 is a flowchart showing a cutting machine registration process in a step S1702 (subroutine) of the flowchart shown in FIG. 17.

FIG. 19 is a sequential chart showing an example of a process executed between the user, the image forming apparatus, the cutting machine, and an external storage device.

FIGS. 20A and 20B are views showing an example of the cut instruction information.

### DESCRIPTION OF THE EMBODIMENTS

Hereafter, embodiments according to the present invention will be described in detail by referring to the drawings. However, configurations described in the following embodiments are merely examples, and the scope of the present invention is not limited by the configurations described in the embodiments. For example, each of the units constituting the present invention can be replaced with any configuration that can exhibit the same function. Further, an arbitrary component may be added. In addition, two or more arbitrary configurations (features) of the embodiments may be combined.

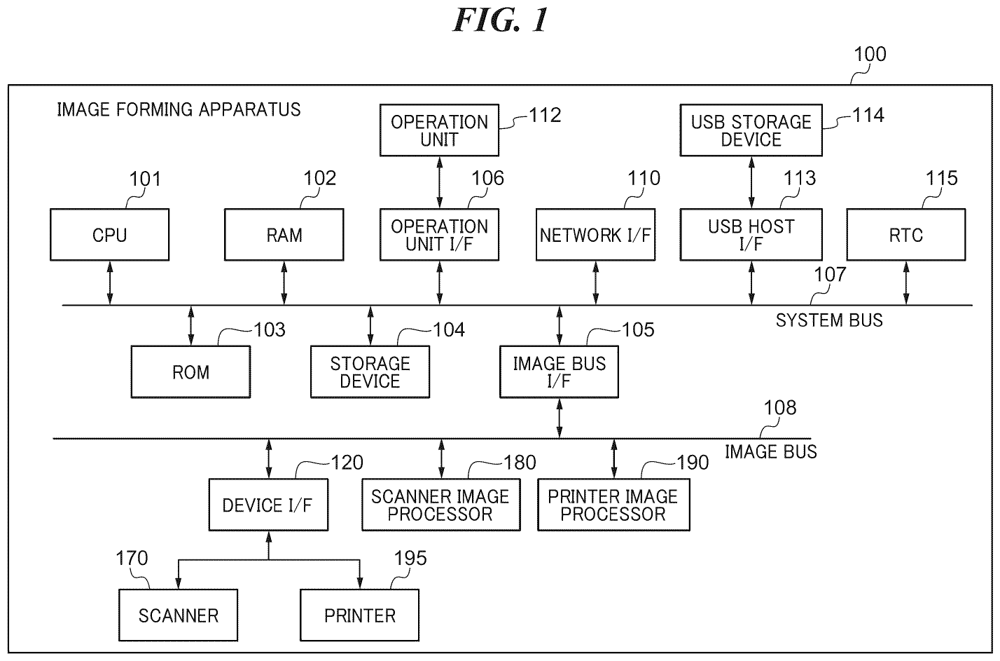

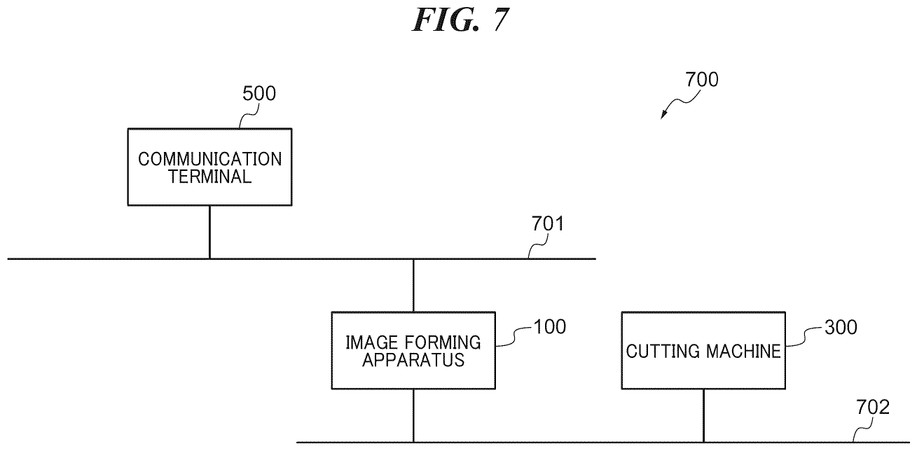

Hereinafter, a first embodiment will be described with reference to FIGS. 1 to 14. FIG. 1 is a block diagram showing a hardware configuration in a case where an information processing apparatus according to the first embodiment is applied to an image forming apparatus. The image forming apparatus 100 shown in FIG. 1 is an MFP (a multi-function peripheral). As shown in FIG. 7, the image forming apparatus 100 is communicably connected to a cutting machine 300 and a communication terminal 500. Further, the image forming apparatus 100 can process information transmitted to and received from the cutting machine 300 and the communication terminal 500.

The image forming apparatus 100 has a CPU 101, a RAM 102, a ROM 103, a storage device 104, an image bus I/F (interface) 105, an operation unit I/F 106, a system bus 107, an image bus 108, and a network I/F 110. Further, the image forming apparatus 100 includes an operation unit (display unit) 112, a USB host I/F 113, a USB storage device 114, an RTC 115, a device I/F 120, a scanner 170, a scanner image processor 180, a printer image processor 190, and a printer 195.

The CPU 101 is a computer that boots an OS (Operation System) by a boot program stored in the ROM 103. The CPU 101 executes various processes on the OS by executing programs stored in the storage device 104. The RAM 102 functions as a work area for the CPU 101 and also as an image memory area for temporarily storing image data.

The storage device 104 stores programs and image data. The programs include, for example, a program for causing the CPU 101 to execute units or means (a control method for the information processing apparatus) of the image forming apparatus 100. The CPU 101 is communicably connected to the ROM 103, RAM 102, operation unit I/F 106, network I/F 110, USB host I/F 113, and image bus I/F 105 via the system bus 107.

The operation unit I/F 106 is an interface with an operation unit 112 having a touch panel. The operation unit I/F 106 transmits the image data to be displayed on the operation unit 112 to the operation unit 112. The operation unit I/F 106 transmits information input from the user through the operation unit 112 to the CPU 101. The network I/F 110 is an interface to connect the image forming apparatus 100 to a LAN.

The USB host I/F 113 is an interface to communicate with the USB storage device 114. The USB host I/F 113 transmits the data stored in the storage device 104 to the USB storage device 114. As a result, the data stored in the storage device 104 is stored in the USB storage device 114. The USB host I/F 113 transmits the data stored in the USB storage device 114 to the CPU 101. The USB storage device 114 is an external storage device that stores data, and is detachably connected to the USB host I/F 113. A plurality of types of USB devices including the USB storage device 114 are connectable to the USB host I/F 113.

The RTC 115 clocks current time. The time information provided from the RTC 115 is used for recording job input time, for example. The image bus I/F 105 is a bus bridge that communicably connects the system bus 107 to the image bus 108 that transfers image data at a high speed and that converts a data format. The image bus 108 is connected to the device I/F 120, the scanner image processor 180, and the printer image processor 190. The scanner 170 and the printer 195 are connected to the device I/F 120. The device I/F 120 performs conversion between synchronous and asynchronous systems of the image data. The scanner image processor 180 corrects, processes, and edits input image data. The printer image processor 190 corrects the print output image data in accordance with the printer 195 and converts resolution.

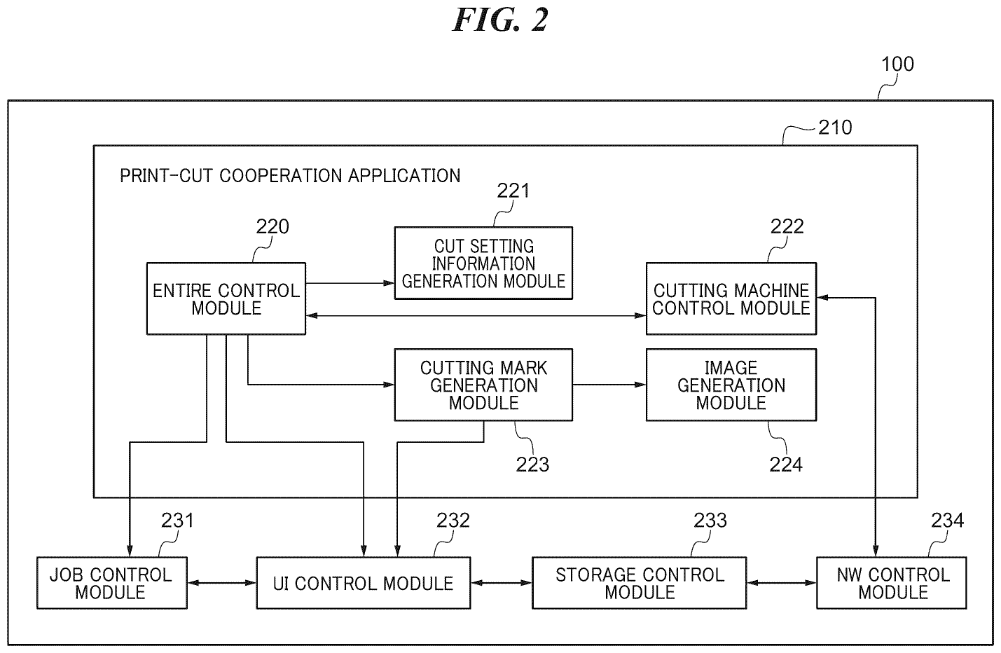

FIG. 2 is a block diagram showing a software configuration of the image forming apparatus 100. As shown in FIG. 2, the image forming apparatus 100 includes a print-cut cooperation application 210, a job control module 231, a UI control module 232, a storage control module 233, and an NW (network) control module 234. Each component is a software module achieved by the CPU 101 executing a main program loaded on the RAM 102. The UI control module 232 displays a screen on the operation unit 112 and receives an operation from the user via the operation unit I/F 106. The UI control module 232 has a function of notifying other modules and a function of controlling screen update by receiving a drawing instruction from another module. The job control module 231 receives a job execution instruction from the UI control module 232 and controls job processes, such as copying, scanning, and printing.

The NW control module 234 receives a communication request from another module to control the network I/F 110. Thus, communication with an external apparatus is controlled. The NW control module 234 also receives a notification from an external apparatus and notifies the other modules of the content of the notification. The storage control module 233 records and manages setting information and job information recorded in the storage device 104. Each module located in a hierarchy of the OS can access the storage control module 233 to refer to or set a setting value.

The print-cut cooperation application 210 is one of sub-modules contained in the OS and controls an application that operates in conjunction with the cutting machine 300. The number of the sub-modules included in the OS is arbitrary. The print-cut cooperation application 210 includes an entire control module 220, a cut setting information generation module (information generating means) 221, a cutting machine control module (information obtaining means) 222, a cutting mark generation module 223, and an image generation module 224.

When receiving a notification of a user operation from the UI control module 232, the entire control module 220 determines a content of the user operation. Then, the entire control module 220 gives instructions to the cut setting information generation module 221, the cutting mark generation module 223, and the cutting machine control module 222 based on the content of the user operation. The entire control module 220 can request the cut setting information generation module 221 to generate cut setting information (cut condition information) related to a cut condition of the cutting machine 300 in cutting (an information generation step). The entire control module 220 can request the cutting mark generation module 223 to generate a cutting mark setting. The cutting mark is a marker attached to a medium that is a cutting object. A cutting position by a tool such as a cutter is determined based on the cutting mark. The entire control module 220 can also request the cutting machine control module 222 to communicate with the cutting machine 300.

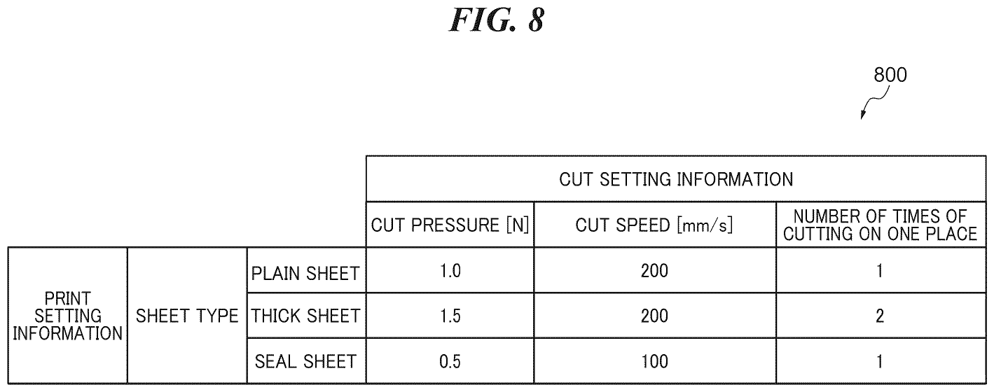

The cut setting information generation module 221 holds a table 800 shown in FIG. 8. The table 800 shows a relationship between print setting information (print condition information) related to a print condition in printing and the cut setting information. That is, in the table 800, the print setting information and the cut setting information are associated with each other. The print setting information is included in a print job output from the communication terminal 500 to the image forming apparatus 100.

When receiving a request to generate the cut setting information from the entire control module 220, the cut setting information generation module 221 generates the cut setting information based on the table 800. The cut setting information generation module 221 can return the cut setting information to the entire control module 220. The cutting machine control module 222 communicates with the cutting machine 300 via the NW control module 234. The cutting machine control module 222 obtains ability information of the cutting machine 300 under the control of the entire control module 220 (an information obtaining step). The ability information relates to the maximum capacity of the cutting machine 300 in cutting.

The cutting machine control module 222 also notifies the cutting machine 300 of the cut setting information and a cut start instruction to start cutting. The cutting mark generation module 223 generates a cutting mark setting corresponding to the ability information of the cutting machine 300. The cutting mark generation module 223 requests the image generation module 224 to generate an image by adding the cutting mark to a print object image under the control of the entire control module 220.

The image generation module 224 accepts the request from the cutting mark generation module 223 and adds the cutting mark corresponding to the user input information to the print object image. The image generation module 224 then returns the print object image to which the cutting mark has been added to the entire control module 220. The entire control module 220 displays the print object image to which the cutting mark has been added on the operation unit 112 via the UI control module 232. When the user instructs the entire control module 220 to execute printing, the entire control module 220 requests the job control module 231 to print the print object image to which the cutting mark has been added.

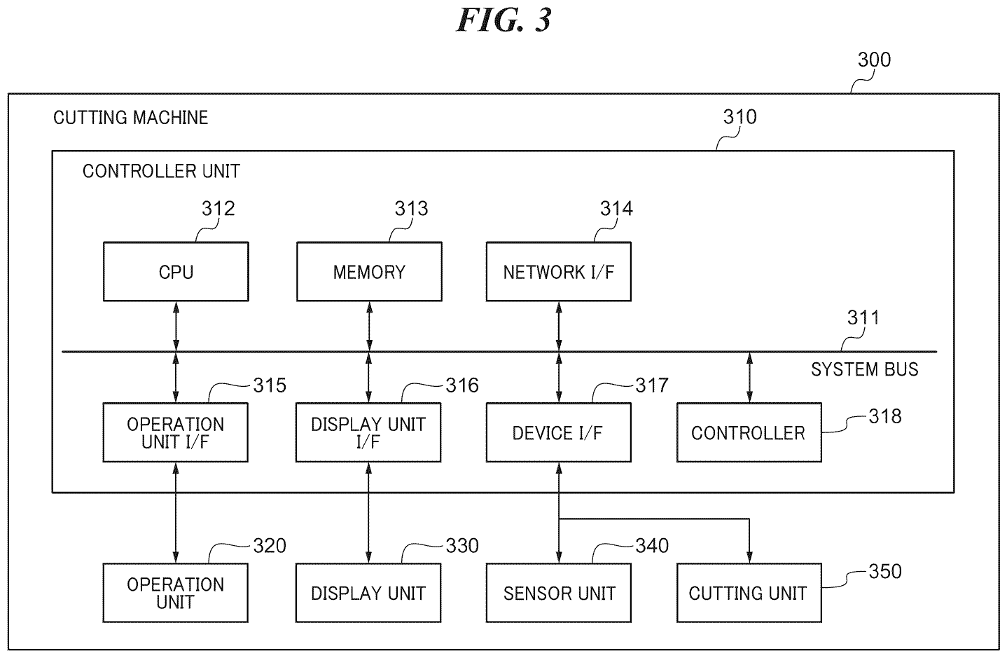

FIG. 3 is a block diagram showing a hardware configuration of the cutting machine 300. The cutting machine 300 shown in FIG. 3 is a device that cuts a sheet medium printed. The cutting machine 300 includes a controller unit 310, an operation unit 320, a display unit 330, a sensor unit 340, and a cutting unit 350. The controller unit 310 includes a CPU 312, a memory 313, a network I/F 314, an operation unit I/F 315, a display unit I/F 316, a device I/F 317, and a controller 318, which are communicably connected to each other via a system bus 311.

The CPU 312 achieves the function of the cutting machine 300 by executing a control program stored in the memory 313. The memory 313 includes, for example, a ROM, a RAM, an HDD, and the like. The memory 313 stores, for example, various data, such as the cut setting (cut condition) and position information, in addition to the control program. The memory 313 may further include an external storage device, such as a USB memory or an external hard disk. The network I/F 314 is an interface to communicate with, for example, the image forming apparatus 100 via the LAN.

The operation unit 320 is connected with the controller unit 310 via the operation unit I/F 315. The display unit 330 is connected to the controller unit 310 via the display unit I/F 316. The sensor unit 340 and the cutting unit 350 are connected to the controller unit 310 via the device I/F 317. The operation unit 320 receives input operations by a user, and is configured by an input device having cursor keys and a determination key, for example.

The display unit 330 displays information such as the cut setting for a user, and is configured by a display device such as a liquid crystal panel. The sensor unit 340 detects a cutting mark on a cutting object medium based on a sensor output and obtains image data by scanning a medium. The cutting unit 350 includes a cutter to cut a cutting object medium, a driving roller to move the cutter, and a conveyance mechanism to move the medium.

The operations of the operation unit 320, the display unit 330, the sensor unit 340, and the cutting unit 350 are controlled by control signals transmitted from the controller 318 of the controller unit 310. Specifically, in order to achieve a cutting process by the cutting machine 300, the controller 318 transmits a control signal to the cutting unit 350 according to signals received from the operation unit 320 and the sensor unit 340. In the cutting unit 350, the medium and the cutter are moved by driving the conveyance mechanism and the driving roller according to the control signal. Thus, the medium can be cut into a predetermined shape.

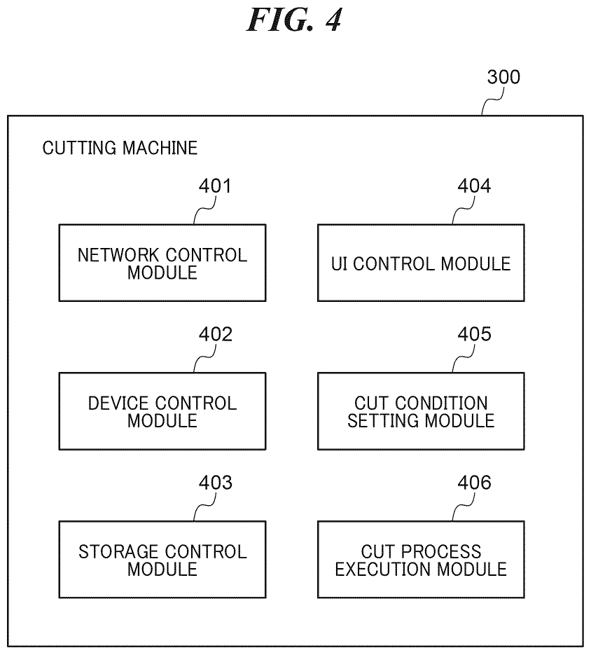

FIG. 4 is a block diagram showing a software configuration of the cutting machine 300. The cutting machine 300 includes a network control module 401, a device control module 402, a storage control module 403, a UI control module 404, a cut condition setting module 405, and a cut process execution unit 406. Each software module is achieved by the CPU 312 executing the control program.

The network control module 401 controls a plurality of communication protocols supported by the cutting machine 300 via the network I/F 314. The device control module 402 is a program to control the sensor unit 340 and the cutting unit 350 via the device I/F 317. The storage control module 403 is a program to manage and control memory access of the memory 313.

The UI control module 404 is a program to control the operation unit 320 via the operation unit I/F 315 and to control the display unit 330 via the display unit I/F 316. The cut condition setting module 405 is a program to receive the cut setting information from the operation unit I/F 315 and the network I/F 314, and to update and store the data in the memory 313. The cut process execution unit 406 is a program to receive a cut execution signal from the operation unit I/F 315 and the network I/F 314 and to control the cutting unit 350 in accordance with the cut setting information.

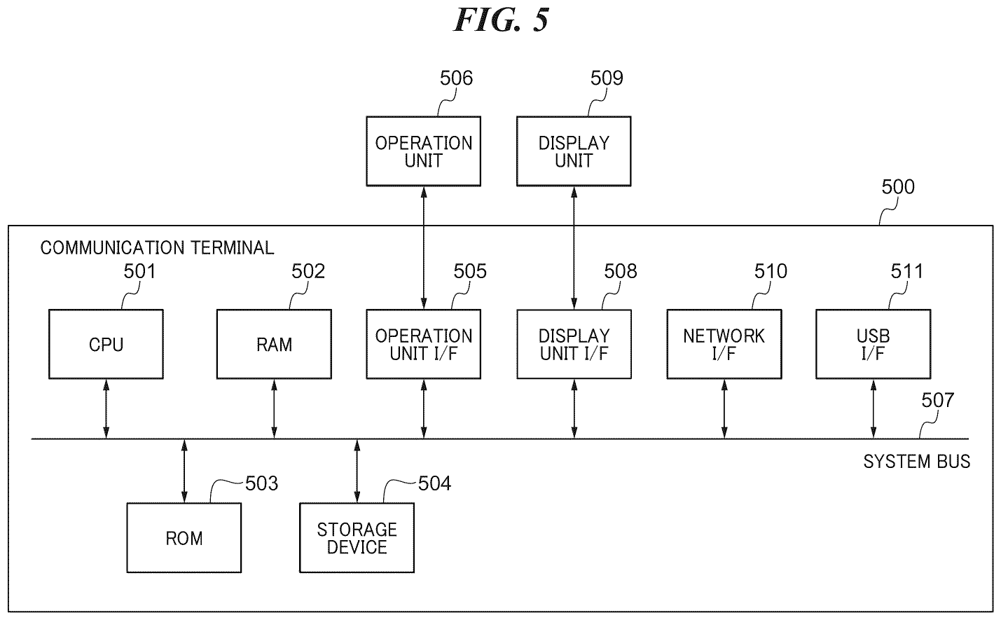

FIG. 5 is a block diagram showing a hardware configuration of the communication terminal 500. The communication terminal 500 shown in FIG. 5, for example, a desktop or notebook personal computer, a tablet terminal, a smartphone, or the like. The communication terminal 500 includes a CPU 501, a RAM 502, a ROM 503, a storage device 504, an operation unit I/F 505, an operation unit 506, a display unit I/F 508, a display unit 509, a network I/F 510, and a USB I/F 511. The CPU 501, RAM 502, ROM 503, storage device 504, operation unit I/F 505, display unit I/F 508, network I/F 510, and USB I/F 511 are connected via a system bus 507 so as to be communicable with each other. The CPU 501 reads the control program stored in the ROM 503 or

the storage device 504 to control functions of the communication terminal 500. In addition, the storage device 504 stores software to control the image forming apparatus 100 to execute printing, that is, a print driver 1001. The RAM 502 is a main storage memory of the CPU 501 and is used as a temporary storage area for developing various control programs stored in the ROM 503 and the storage device 504. The ROM 503 stores a control program executable by the CPU 501. The storage device 504 is an SSD, an HDD, or the like, and stores image data and application programs.

The operation unit I/F 505 is communicatively connected with the operation unit 506. The operation unit 506 is a device to detect an input from a user, and includes, for example, a mouse, a keyboard, etc. The display unit I/F 508 is communicably connected with the display unit 509. The display unit 509 is a device to display process contents of the communication terminal 500 so that a user can grasp the process contents, and has, for example, a liquid crystal monitor. The network I/F 510 transmits and receives data to and from the image forming apparatus 100, for example. The USB I/F 511 transmits and receives data to and from an external device like a USB memory via a USB-compliant cable. The operation unit 506 may be connected to the communication terminal 500 via the USB I/F 511.

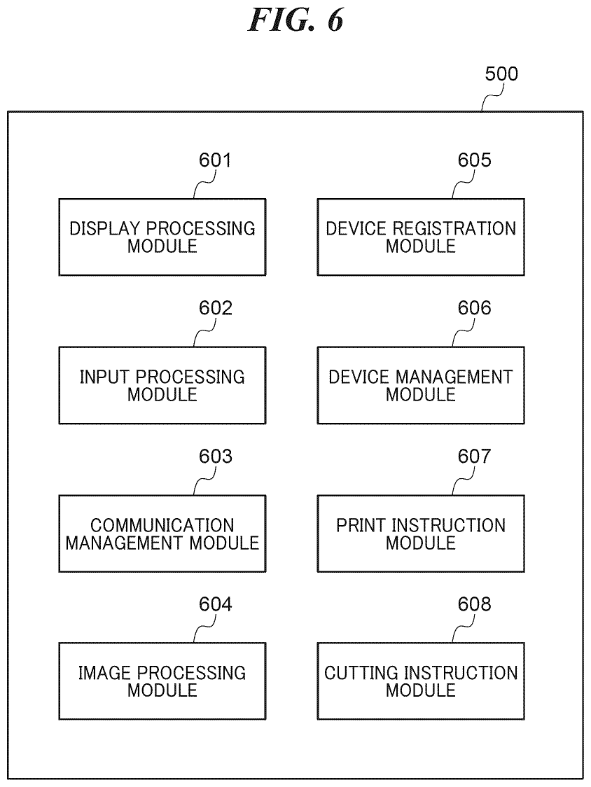

FIG. 6 is a block diagram showing a software configuration of the communication terminal 500. As shown in FIG. 6, the communication terminal 500 includes a display processing module 601, an input processing module 602, a communication management module 603, an image processing module 604, a device registration module 605, a device management module 606, a print instruction module 607, and a cutting instruction module 608. These software modules of the communication terminal 500 are application software programs stored in the storage device 504 of the communication terminal 500, and can cooperate with the image forming apparatus 100 and the cutting machine 300.

The display processing module 601 controls contents displayed on the display unit 509 in executing an application. The input processing module 602 detects an input from the operation unit 506 in executing the application and transmits the input information to other software modules. The communication management module 603 controls communications with the image forming apparatus 100 and the cutting machine 300 via the network I/F 510. The image processing module 604 generates image data with a cutting mark, print data, cutting data, etc. according to a user operation input from the input processing module 602.

The device registration module 605 detects the image forming apparatus 100 and the cutting machine 300 connected via the network I/F 510 and the USB I/F 510, and stores information about each device in the storage device 504. The information about the device includes, for example, device type information and device communication information. The device management module 606 updates or deletes the information about the device registered by the device registration module 605. Although the device registration module 605 and the device management module 606 are included in the application software in this embodiment, this is not limiting. For example, the device registration module 605 and the device management module 606 may achieve the functions by cooperating with a driver software module stored in the storage device 504 of the communication terminal 500.

The print instruction unit 607 transmits the print data to the image forming apparatus 100 according to the user operation input from the input processing module 602. For this transmission, the device communication information managed by the device management module 606 is used. The cutting instruction module 608 transmits data required for cutting to the cutting machine 300 according to the user operation input from the input processing module 602. For this transmission, the device communication information managed by the device management module 606 is used.

FIG. 7 is a block diagram showing an information processing system. The information processing system 700 shown in FIG. 7 includes the image forming apparatus 100, the cutting machine 300, and the communication terminal 500. The image forming apparatus 100 and the communication terminal 500 are connected via a network 701 so as to be communicable with each other. The image forming apparatus 100 and the cutting machine 300 are connected via a network 702 different from the network 701 so as to be communicable with each other.

Although the image processing system 700 shown in FIG. 7 includes the one image forming apparatus 100, one cutting machine 300, and one communication terminal 500, two or more image forming apparatuses, two or more cutting machines, or two or more communication terminals may be included. Further, the cutting machine 300 and the communication terminal 500 may be connected to be communicable with each other via the network 701, the network 702, or a network different from them.

FIG. 8 is the table showing the example the cut setting information (cut condition information) that is generated by the image forming apparatus based on the print setting information (print condition information). In the table 800, media to be printed, that is, sheet types are listed as examples of the print setting information. Further, a plain sheet, a thick sheet, and a seal sheet are exemplified as the sheet types. In addition, cut pressure, cut speed, and the number of times of cutting on one place are given as examples of the cut setting information.

The “cut pressure” is a pressing force pressing a cutting blade of the cutter against a medium as a cutting object in cutting. The “cut speed” is a speed of the cutter in cutting. The “number of times of cutting on one place” is the number of times of cutting per one place of a sheet in cutting. For example, when a part of a sheet is cut along a circular cut instruction line (cutting line), the number of rounds that the cutter moves along the cut instruction line depends on thickness of the sheet.

All of the cut pressure, the cut speed, and the number of times of cutting on one place are set within the range of the capability indicated by the ability information of the cutting machine 300. For example, when the cutting object is the plain sheet, the cut setting information is set so that the cut pressure is 1.0 N, the cut speed is 200 mm/s, and the number of times of cutting on one place is 1 time. In addition, when the cutting object is the thick sheet, the cut setting information is set so that the cut pressure is 1.5 N, the cut speed is 200 mm/s, and the number of times of cutting on one place is 2 times. In this way, in this embodiment, the specific numerical values (information regarding parameters) of the cut pressure, the cut speed, and the number of times of cutting on one place corresponding to the sheet type are obtained as the cut setting information. Thus, the cut setting information generation module 221 can generate the cut setting information based on the table 800 (the ability information and the print setting information). That is, the cut setting information generation module 221 can generate the cut setting information based on the print setting information within the range of the capability indicated by the ability information. This cut setting information is stored in the RAM 102.

Although the cut setting information includes the three parameters including the cut pressure, the cut speed, and the number of times of cutting on one place, this is not limiting. The cut setting information may include at least one of the three parameters or may further include another parameter. The cut setting information generated by the cut setting information generation module 221 is transmitted to the cutting machine 300 at a timing before the transmission of the cut instruction. The cutting machine 300 then cuts a cutting object based on the cut setting information.

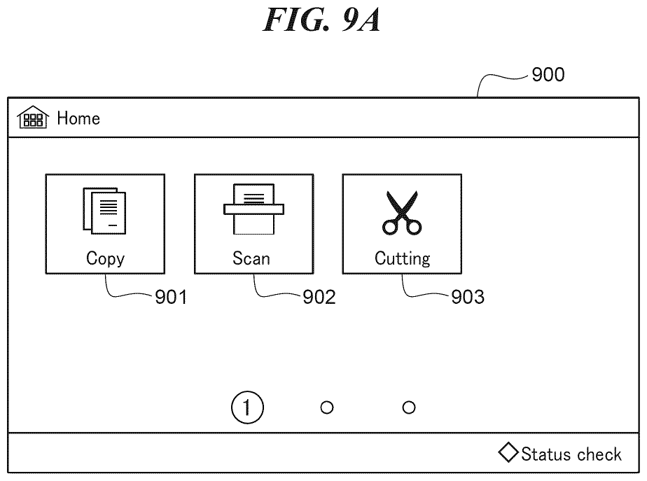

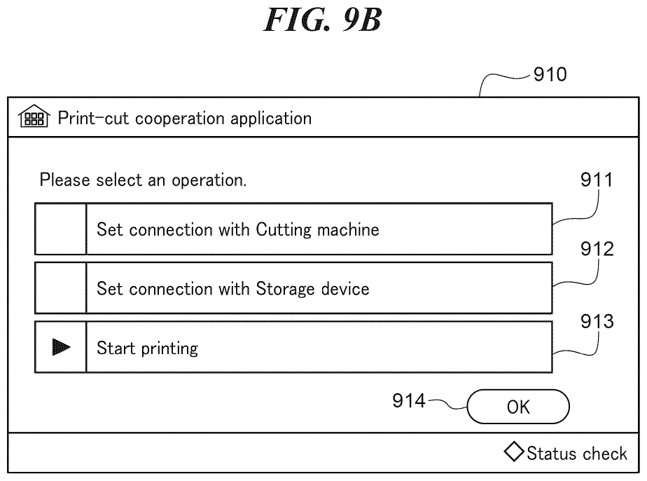

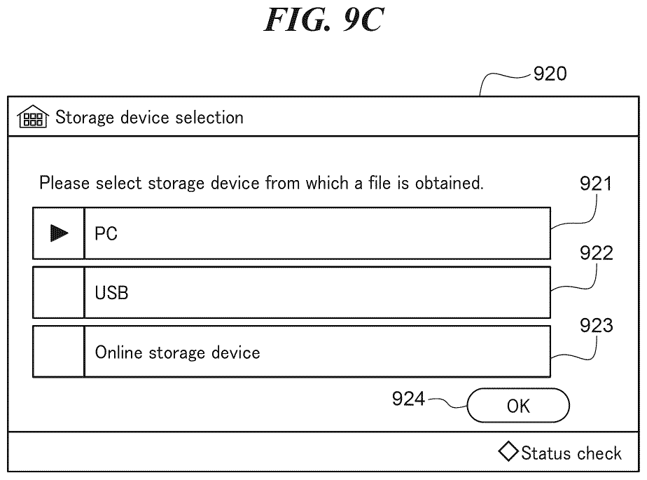

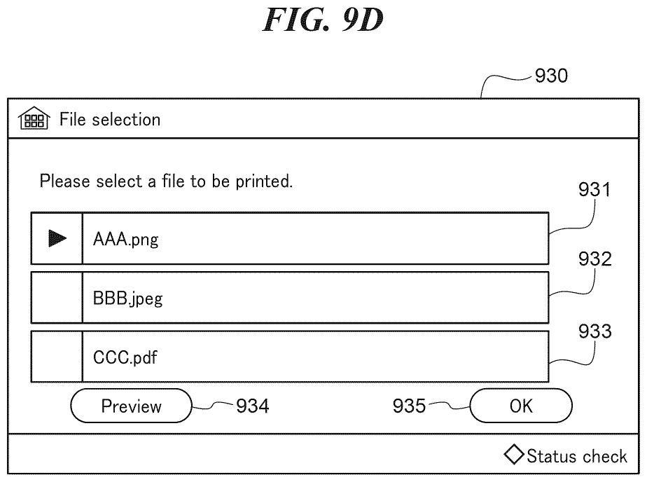

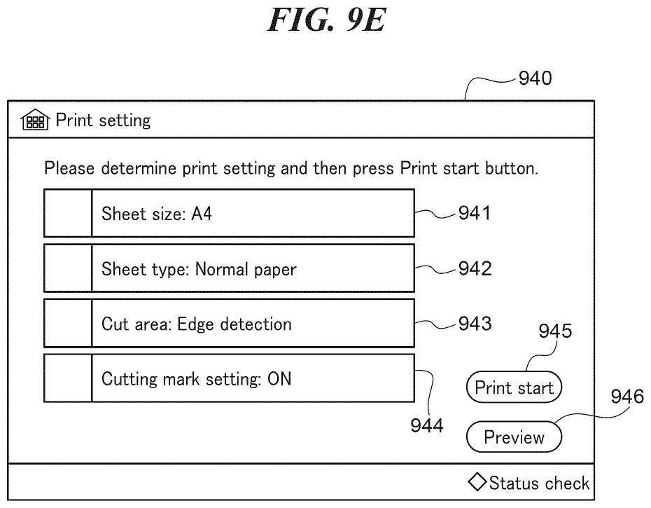

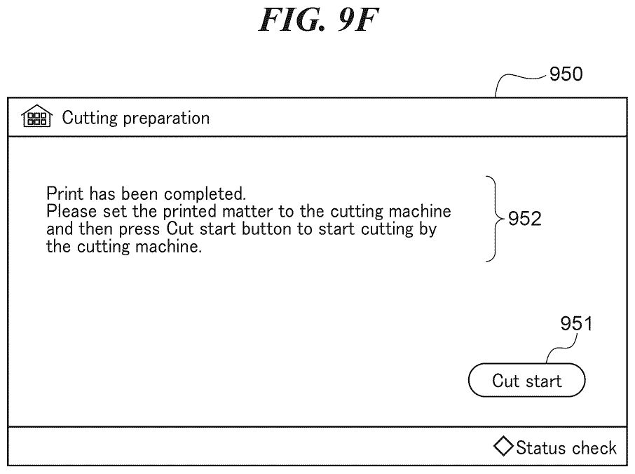

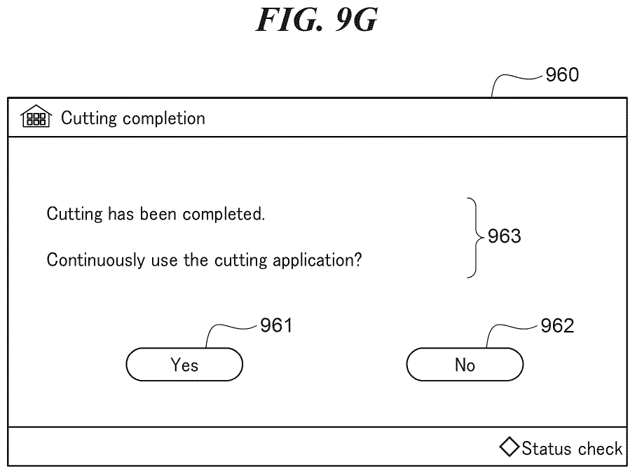

FIGS. 9A to 9G are views showing examples of operation screens displayed on the image forming apparatus. The operation screens shown in FIGS. 9A to 9G are generated by the CPU 101 executing the program constituting the UI control module 232 and are displayed on the operation unit 112.

FIG. 9A is a view showing an example of a home screen 900 of the image forming apparatus. FIG. 9B is a view showing an example of a home screen 920 of the print-cut cooperation application (an application home screen). FIG. 9C is a view showing a storage selection screen 920 selecting a storage device, which is an obtaining source of a print data file. FIG. 9D is a view showing a file selection screen 930 selecting a print data file. FIG. 9E is a view showing a print setting screen 940 for setting the print condition in printing the print data file. FIG. 9F is a view showing a cutting preparation screen 950 to prompt preparation for cutting by the cutting machine. FIG. 9G is view showing a cutting completion screen 960 to notify a user of the completion of the cutting by the cutting machine.

The home screen 900 shown in FIG. 9A includes a copy icon 901, a scan icon 902, and a cutting icon 903. When the copy icon 901 is operated (pressed), the image forming apparatus 100 executes copying. When the scan icon 902 is operated, the image forming apparatus 100 executes scan. When the cutting icon 903 is operated, the print-cut cooperation application 210 is activated. This allows cutting by the cutting machine 300. In this way, the cutting icon 903 has a function as a selecting operation means that is operated by the user to select whether to cut the medium by the cutting machine 300. Then, when the print-cut cooperation application 210 is activated, the displayed screen shifts to the application home screen 910 shown in FIG. 9B.

The application home screen 910 includes a cutting machine connection setup region 911, a storage device connection setting region 912, a print start region 913, and an OK button 914. When the cutting machine connection setting area 911 and the OK button 914 are sequentially operated, the connection with the cutting machine 300 can be set. Then, when the connection setting with the cutting machine 300 is completed, the ability information of the cutting machine 300 can be obtained.

Thus, in this embodiment, the cutting machine connection setting region 911 has a function as an obtaining operation means that is operated by the user to instruct obtaining the ability information. Further, when the storage device connection setting region 912 and the OK button 914 are sequentially operated, authentication information in connecting to the online storage device can be set. The online storage device is a cloud service that lends a storage area of a storage device via a network. Further, when the print start region 913 and the OK button 914 are sequentially operated, the displayed screen shifts to the storage selection screen 920 shown in FIG. 9C.

The storage selection screen 920 includes a PC region 921, a USB region 922, an online storage region 923, and an OK button 924. When the PC region 921 and the OK button 924 are sequentially operated, a PC (for example, the communication terminal 500) can be selected as an obtaining source of a print data file, that is, a print job. This enables the PC to obtain the print data file. In this way, in this embodiment, the PC region 921 has a function as a job obtaining operation means that is operated by the user to instruct obtaining the print data file.

Further, when the USB region 922 and the OK button 924 are sequentially operated, a USB can be selected as the obtaining source of the print data file. When the online storage region 923 and the OK button 924 are sequentially operated, the online storage device can be selected as the obtaining source of the print data file. When the connection to the external storage device is successful, the displayed screen shifts to the file selection screen 930 shown in FIG. 9D. On the other hand, if the connection to the external storage device fails, an error message indicating the failure is displayed, and the displayed screen shifts to the application home screen 910.

The file selection screen 930 displays regions indicating file names of printable print data files among the print data files stored in the external storage device selected on the storage selection screen 920. As the regions indicating the file names of the print data files, file name regions 931, 932, and 933 are displayed. The file name region 931 indicates a name of a file in a raster image file format. The file name region 932 indicates a name of a file in the JPEG format. The file name region 933 indicates a name of a file in the PDF format. The file selection screen 930 includes a preview button 934 and an OK button 935. When any of the file name regions 931 to 933 is selected and the preview button 934 is operated, the image data of the selected file can be displayed as a preview image on the operation unit 112. Further, when any of the file name regions 931 to 933 is selected and the OK button 935 is operated, the displayed screen shifts to the print setting screen 940 shown in FIG. 9E.

The print setting screen 940 includes setting item fields for setting print conditions in printing a data file. As the setting item fields, for example, a sheet size field 941, a sheet type field 942, a cut area field 943, and a cutting mark setting field 944 are displayed. In the sheet size field 941, a printable sheet size (for example, A4 size, A3 size, B4 size, or the like) that is supported by the image forming apparatus 100 in printing can be set. In the sheet type field 942, a type of a sheet (for example, a plain sheet, a thick sheet, a coated sheet, or the like) that is supported by the image forming apparatus 100 in printing can be set.

The image forming apparatus 100 may restrict selection of sheets other than the sheets of which the sheet sizes and sheet types can be supported by the image forming apparatus 100 and the cutting machine 300 based on the ability information of the cutting machine 300. In this case, the selectable items are filtered in the sheet size field 941 and the sheet type field 942. As described above, the ability information is information about the maximum capacity of the cutting machine 300 in cutting. A cut area that is one of the cut setting information transmitted to the cutting machine 300 can be set in the cut area field 943.

As described above, the cut setting information relates to the cut condition in cutting by the cutting machine 300. The cut area defines a cut line along which a printed matter is cut by the cutting machine 300. In this embodiment, a square or circular area can be set as the cut area, or an edge of an image can be detected by the cut setting information generation module 221 based on the print data file and the cut area can set to the detected edge.

In the cutting mark setting field 944, addition of the cutting mark can be set. Specifically, it is possible to set whether to print the cutting mark to correct the position information before cutting by the cutting machine 300, and to set the shape of the cutting mark in printing the cutting mark. A print start button 945 is included in the print setting screen 940. When the print start button 945 is operated after the settings in the sheet size field 941 to the cutting mark setting field 944, the printing of the print data file selected on the file selection screen 930 starts. After the printing is completed, the displayed screen shifts to the cutting preparation screen 950 shown in FIG. 9F.

The print setting screen 940 includes a preview button 946. When the preview button 946 is operated after the settings in the sheet size field 941 etc., a composite image in which the cutting mark and the cut area are combined with the image of the print data file is generated. As a sample of the composite image, a preview image is displayed on the operation unit 112.

The cutting preparation screen 950 includes a cut start button 951 and a message 952. The message 952 includes an indication that printing is completed, an indication to prompt a user to set the printed matter to the cutting machine 300, and an indication to prompt the user to operate the cut start button 951. When the user operates the cut start button 951 after setting the printed matter printed by the image forming apparatus 100 to the cutting machine 300, the image forming apparatus 100 transmits the cut setting information to the cutting machine 300. In this way, the cut start button 951 has a function as a transmitting operation means that is operated by the user to instruct transmission of the cut setting information from the network I/F 110 (information transmitting means).

The cut start button 951 also functions as a cutting operation means that is operated by the user to instruct cutting by the cutting machine 300. A portion having the function as the transmitting operation means and a portion having the function as the cutting operation means may be provided independently. Further, when the user operates the cut start button 951, the coordinate data of the cut line defining the cut area is also transmitted together with the cut setting information. The cutting machine 300 can cut the printed matter based on the cut setting information.

After the transmission of the cut setting information, etc. to the cutting machine 300 is completed, the displayed screen shifts to the cutting completion screen 960 shown in FIG. 9G. The cutting completion screen 960 includes a Yes button 961, a No button 962, and a message 963. The message 963 includes an indication that the cutting by the cutting machine 300 is completed and an indication whether to use the print-cut cooperation application 210 continuously. When the Yes button 961 is operated, the displayed screen shifts to the file selection screen 930 and the print-cut cooperation application 210 can be continuously used.

When the Yes button 961 is operated, the displayed screen may shift to the application home screen 910 or the storage selection screen 920. On the contrary, when the No button 962 is operated, the displayed screen shifts to the home screen 900 and the print-cut cooperation application 210 is terminated.

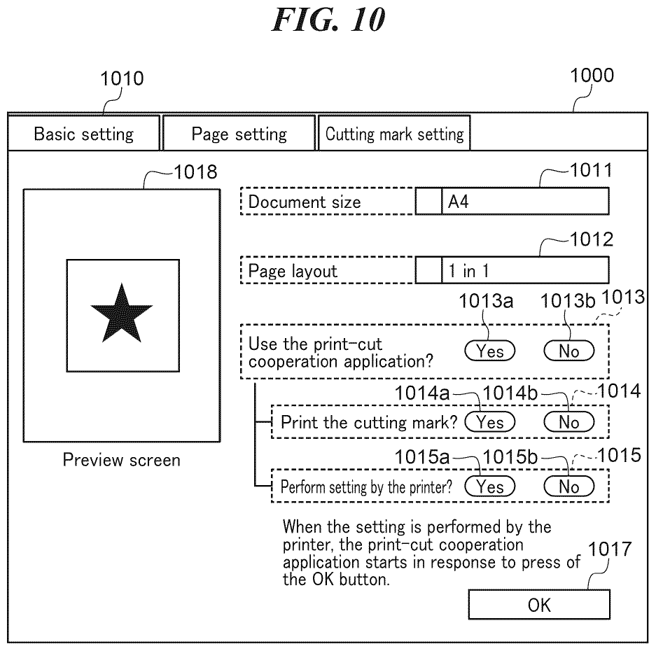

FIG. 10 is a view showing an example of an operation screen displayed by a print driver for the image forming apparatus running on the communication terminal. The print driver 1001 is a software module achieved by the CPU 501 of the communication terminal 500 executing a main program loaded to the RAM 502. There are a plurality of types of print drivers depending on types of image forming apparatuses. For example, there are a print driver for the image forming apparatus 100 that cooperates with the cutting machine 300 and a print driver for an image forming apparatus that does not cooperate with the cutting machine 300, etc.

The user downloads the print driver 1001 to the RAM 502 via a web page, a USB, a disk, or the like. The downloading method is not particularly limited. The user starts the communication terminal 500 and displays an operation screen 1000 shown in FIG. 10 on the operation unit 112. Contents displayed on the operation screen 1000 may depend on a type of an image forming apparatus.

The operation screen 1000 includes a basic setting screen 1010. The basic setting screen 1010 includes a document size drop-down list 1011, a page layout drop-down list 1012, radio button areas 1013, 1014, and 1015, an OK button 1017, and a preview image 1018. In the document size drop-down list 1011, a size of a sheet (medium) on which an image is printed can be selected (designated). Sheet sizes selectable in the document size drop-down list 1011 are not particularly limited. For example, A4 size and B5 size are selectable. In the example shown in FIG. 10, the A4 size is selected in the document size drop-down list 1011.

In the page layout drop-down list 1012, a page layout can be selected. Page layouts selectable in the page layout drop-down list 1012 are not particularly limited. For example, “1 in 1” in which one page is included per sheet and “2 in 1” in which two pages are included per sheet are selectable.

In the radio button area 1013, the user can select whether to use the option of using print-cut cooperation application 210. The radio button area 1013 includes a Yes button 1013a and a No button 1013b. An operation of the Yes button 1013a allows use of the print-cut cooperation application 210 and an operation of the radio button area 1014. On the contrary, an operation of the No button 1013b closes the operation screen 1000 and restricts further use of the print-cut cooperation application 210.

In the radio button area 1014, the user can select whether to add a cutting mark to a sheet to be printed by the print-cut cooperation application 210. The radio button area 1014 includes a Yes button 1014a and a No button 1014b. An operation of the Yes button 1014a allows addition of the cutting mark and an operation of the radio button area 1015. On the contrary, an operation of the No button 1014b omits the addition of the cutting mark.

In the radio button area 1015, the user can select whether to perform print setting via the operation unit 112 of the image forming apparatus 100. The radio button area 1015 includes a Yes button 1015a and a No button 1015b. An operation of the Yes button 1015a allows the print setting of the image forming apparatus via the operation unit 112. On the contrary, an operation of the No button 1015b allows printing based on the print setting on the operation screen 1000. When the OK button 1017 is operated, the setting contents set on the operation screen 1000 are transmitted to the image forming apparatus 100 via the network I/F 510 of the communication terminal 500.

Then, the image forming apparatus 100 can receive the setting contents set on the operation screen 1000 via the network I/F 110. The CPU 101 of the image forming apparatus 100 executes the main program loaded to the RAM 102 based on the setting contents. When the Yes button 1013a in the radio button area 1013 is operated, the CPU 101 executes the print-cut cooperation application 210. In addition, when detailed setting items (not illustrated) are set in the radio button area 1015, the print-cut cooperation application 210 can display each screen shown in FIGS. 9A to 9G. The preview image 1018 indicates a sample of a sheet including a print image and a cut area.

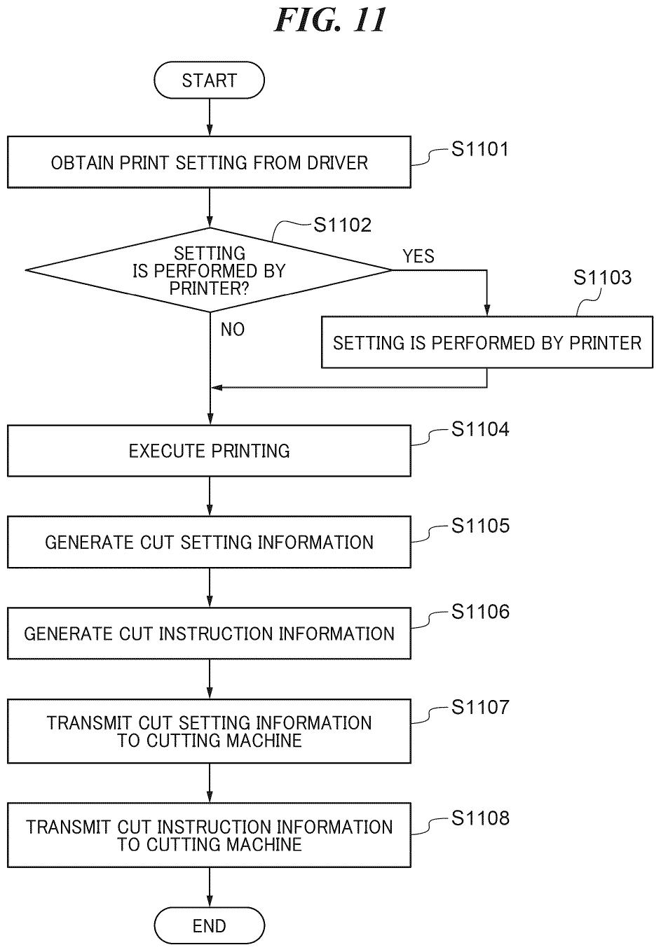

FIG. 11 is a flowchart showing an example of the process executed by the print-cut cooperation application. Each step in the flowchart shown in FIG. 11 is achieved by the CPU 101 developing the program stored in the ROM 103 or the storage device 104 of the image forming apparatus 100 to the RAM 102 and running the program.

As shown in FIG. 11, the CPU 101 of the image forming apparatus obtains the print job from the print driver 1001 of the communication terminal 500 via the network I/F 110 (a job obtaining means) in a step S1101 (a job obtaining step). The print job includes image data to be printed on a sheet, print setting information, etc. Further, the print setting information includes a type of a sheet on which an image is printed, etc. The CPU 101 requests the storage control module 233 to store the print setting information in the RAM 102.

Also, when the print setting information includes information indicating that the Yes button 1013a is selected in the radio button area 1013, the CPU 101 executes the print-cut cooperation application 210. When the print-cut cooperation application 210 is executed, the entire control module 220 refers to the storage control module 233 and obtains the print setting information from the print driver 1001.

In a step S1102, the entire control module 220 refers to the information about the radio button area 1015 included in the print setting information and determines whether the setting is performed by the printer. When the print setting information includes information indicating that the Yes button 1015a is selected in the radio button area 1015, it is determined that the setting is performed by the printer and the process proceeds to a step S1103. On the contrary, when the print setting information includes information indicating that the No button 1015b is selected in the radio button area 1015, it is determined that the setting is not performed by the printer and the process proceeds to a step S1104.

In the step S1103, the entire control module 220 controls the UI control module 232 to display the print setting screen 940 shown in FIG. 9E on the operation unit 112. When the print start button 945 in the print setting screen 940 is operated, the entire control module 220 replaces the information already obtained from the print driver 1001 with the print setting information set by the print setting screen 940 to update the print setting information and proceeds with the process to the step S1104.

In the step S1104, the entire control module 220 requests the job control module 231 to perform printing based on the print setting. The entire control module 220 displays the cutting preparation screen 950 shown in FIG. 9F on the operation unit 112 after the printing is completed. When the cut start button 951 in the cutting preparation screen 950 is operated, the process proceeds to a step S1105.

In the step S1105, the entire control module 220 requests the cut setting information generation module 221 to generate the cut setting information. The cut setting information generation module 221 generates the cut setting information (see FIG. 8) based on the ability information of the cutting machine and the print setting information obtained in the step S1101 or the print setting information reversed in the step S1103.

The cut setting information is saved (stored) in a memory unit, such as the storage device 104 or the RAM 102. For example, when the sheet type of the print setting information is the plain sheet, the cut setting information defining that the cut pressure is 1.0 N, the cut speed is 200 mm/s, and the number of times of cutting on one place is one is generated. A sheet cassette of the image forming apparatus 100 may be designated as the sheet type in the print setting information. In this case, the cut setting information is generated after a type of sheets stored in the sheet cassette is specified with reference to information set in the sheet cassette.

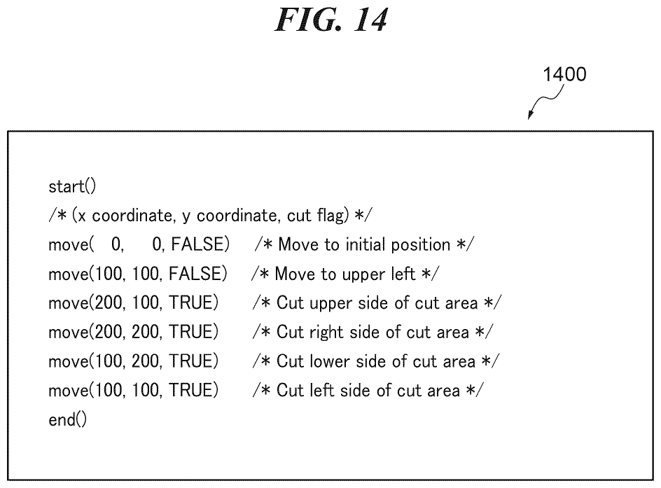

In a step S1106, the entire control module 220 requests the cut setting information generation module 221 to generate cut instruction information 1400 shown in FIG. 14. The cut instruction information 1400 includes coordinates of a cut area on a sheet. The cut setting information generation module 221 selects a cutting target from the image on the sheet to be printed and generates the cut instruction information 1400. The cut instruction information 1400 is stored in a memory unit, such as the storage device 104 or the RAM 102.

In a step S1107, the entire control module 220 requests the cutting machine control module 222 to transmit the cut setting information to the cutting machine 300. The cutting machine control module 222 transmits the cut setting information stored in the storage device 104, the RAM 102, or the like to the cutting machine 300 via the NW control module 234. When receiving the cut setting information, the cutting machine 300 notifies the entire control module 220 of that matter.

In a step S1108, the entire control module 220 requests the cutting machine control module 222 to transmit the cut instruction information 1400 to the cutting machine 300. The cutting machine control module 222 transmits the cut instruction information 1400 stored in the storage device 104, the RAM 102, or the like to the cutting machine 300 via the NW control module 234. When receiving the cut instruction information 1400, the cutting machine 300 notifies the entire control module 220 of that matter.

The cut setting information and the cut instruction information 1400 become obtainable by the cutting machine 300 when they are transmitted to the cutting machine 300 in this embodiment. However, this is not limiting. For example, the cut setting information or the cut instruction information 1400 may be temporarily stored in a USB memory. In such a case, the user connects the USB memory to the cutting machine 300 so that the cut setting information or the cut instruction information 1400 can be obtainable by the cutting machine 300.

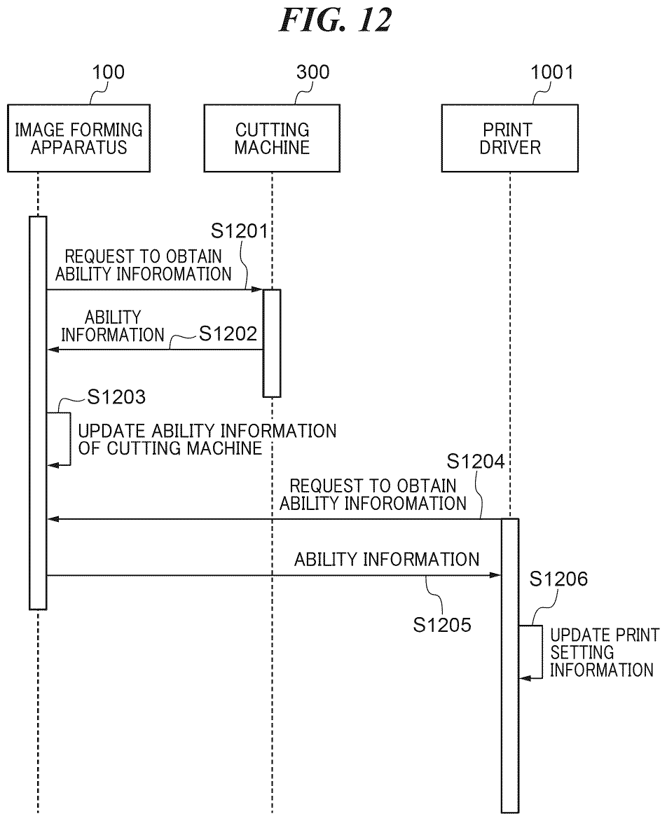

FIG. 12 is a sequential chart showing an example of a process performed between the image forming apparatus 100, the cutting machine 300, and the print driver 1001. Once the setting is updated, the process in steps S1201 to S1206 in the sequential chart shown in FIG. 12 is not executed until the next update timing. The next update timing is a timing at which the image forming apparatus 100 or the print driver 1001 is rebooted. As shown in FIG. 12, when the image forming apparatus 100 is booted, the image forming apparatus 100 (the OS) requests the cutting machine 300 on the network 702 to obtain the ability information of the cutting machine 300 in the step S1201.

In the step S1202, the cutting machine 300 returns the ability information of the cutting machine 300 in response to the request in the step S1201. The ability information includes, for example, information about upper/lower limit values of the cut pressure, the cut speed, the number of times of cutting on one place (see FIG. 8), the shape of the cutting mark, etc.

In the step S1203, the image forming apparatus 100 (the OS) controls the storage control module 253 to update, if necessary, the ability information of the cutting machine 300 with the information obtained in the step S1202.

In the step S1204, the print driver 1001 requests the image forming apparatus 100 to obtain ability information of the image forming apparatus 100.

In the step S1205, the image forming apparatus 100 returns the ability information of the image forming apparatus 100 to the print driver 1001 in response to the request in the step S1204. The ability information includes the ability information of the cutting machine 300, the information about sheet sizes and sheet types supported by the image forming apparatus 100, etc.

In the step S1206, the print driver 1001 updates the print setting information based on the ability information of the image forming apparatus 100 returned in the step S1205. The print driver 1001 displays the operation screen 1000 shown in FIG. 10 based on the updated information.

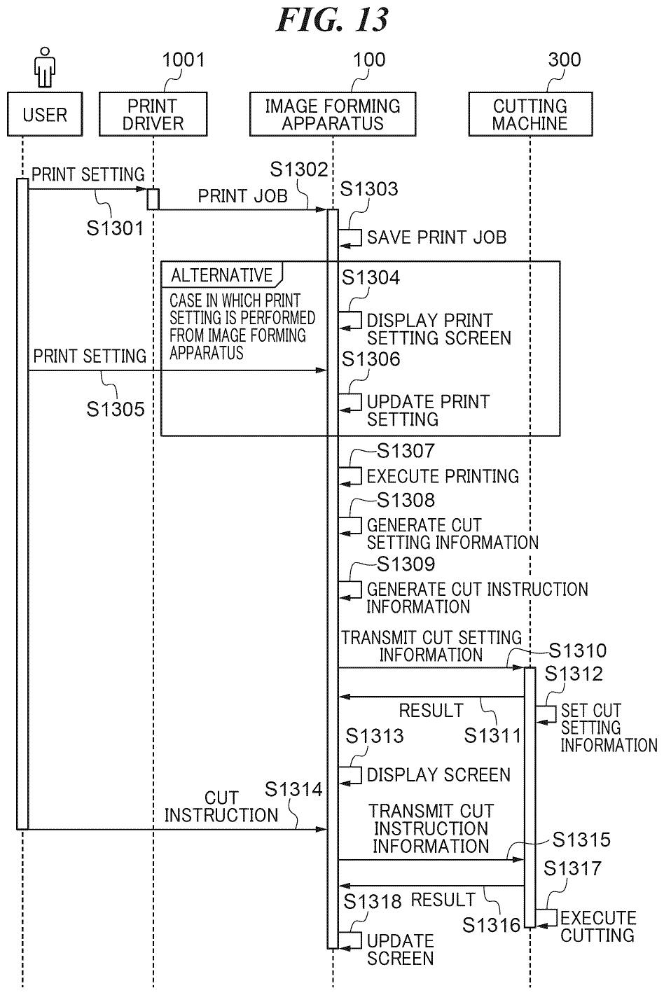

FIG. 13 is a sequential chart showing an example of a process performed between the user, the print driver 1001, the image forming apparatus 100, and the cutting machine 300. As shown in FIG. 13, in a step S1301, the user performs print setting on the operation screen 1000 (see FIG. 10) displayed on the operation unit 506 of the communication terminal 500. When the OK button 1017 in the operation screen 1000 is operated, the process proceeds to a step S1302.

In the step S1302, the print driver 1001 of the communication terminal 500 transmits the print job including the print setting information set on the operation screen 1000 and the data of the print image to the image forming apparatus 100 via the network I/F 510.

In a step S1303, the OS of the image forming apparatus 100 receives the print job transmitted in the step S1302 via the network I/F 110 and stores the print job in the RAM 102 or the storage device 104. When the print setting information of the print job includes information indicating that the Yes button 1013a in the radio button area 1013 is selected, the print-cut cooperation application 210 is loaded into the RAM 102 and becomes executable.

In addition, when the print setting information includes information indicating that the Yes button 1015a in the radio button area 1015 is selected, the process proceeds to a step S1304. On the contrary, when the print setting information includes information indicating that the No button 1015b in the radio button area 1015 is selected, the process proceeds to a step S1307.

In the step S1304, the entire control module 220 of the image forming apparatus 100 requests the UI control module 232 to display the print setting screen 940 (see FIG. 9E).

In a step S1305, the user performs the print setting on the operation unit 112 of the image forming apparatus 100. In a step S1306, the entire control module 220 of the image forming apparatus 100 changes the print setting information already obtained from the print driver 1001 to the print setting information set in the step S1305, and proceeds with the process to the step S1307.

In the step S1307, the entire control module 220 of the image forming apparatus 100 requests the job control module 231 to print based on the print setting information. The job control module 231 controls the printer 195 to execute the print job. Thus, an image can be printed on a sheet. In a case where the print setting is performed in the step S1305, the print job is executed in the step S1307 by the entire control module 220 receiving a notification that the print start button 945 is operated from the UI control module 232.

In a step S1308, the entire control module 220 of the image forming apparatus 100 requests the cut setting information generation module 221 to generate the cut setting information. The cut setting information generation module 221 generates the cut setting information (see FIG. 8) as described above. The cut setting information generation module 221 returns the cut setting information to the entire control module 220.

In a step S1309, the entire control module 220 of the image forming apparatus 100 requests the cut setting information generation module 221 to generate the cut instruction information 1400 (see FIG. 14). The cut setting information generation module 221 generates the cut instruction information 1400 as described above. The cut setting information generation module 221 returns the cut instruction information to the entire control module 220.

In a step S1310, the entire control module 220 of the image forming apparatus 100 requests the cutting machine control module 222 to transmit the cut setting information to the cutting machine 300. The cutting machine control module 222 transmits the cut setting information to the cutting machine 300 via the NW control module 234.

In a step S1311, the cutting machine control module 222 of the image forming apparatus 100 returns a result of the transmission to (communication with) the cutting machine 300 in the step S1310 to the entire control module 220.

In a step S1312, the cut condition setting module 405 of the cutting machine 300 receives the cut setting information transmitted in the step S1310 via the network I/F 314 and updates the settings according to the cut setting information.

In a step S1313, the entire control module 220 of the image forming apparatus 100 requests the UI control module 232 to display the cutting preparation screen 950 (see FIG. 9F).

In a step S1314, the user can issue a cut instruction on the cutting preparation screen 950. When the cut start button 951 in the cutting preparation screen 950 is operated, the process proceeds to a step S1315.

In the step S1315, the entire control module 220 of the image forming apparatus 100 requests the cutting machine control module 222 to transmit the cut instruction information to the cutting machine 300. The cutting machine control module 222 transmits the cut instruction information to the cutting machine 300 via the NW control module 234.

In a step S1316, the cutting machine control module 222 of the image forming apparatus 100 returns the result of the transmission to (communication with) the cutting machine 300 in the step S1315 to the entire control module 220.

In a step S1317, the cut process execution module 406 of the cutting machine 300 receives the cut instruction information via the network I/F 314. Thus, the cutting machine 300 can cut a medium based on the cut instruction information.

When receiving the notification of the transmission result in the step S1316, the entire control module 220 of the image forming apparatus 100 requests the UI control module 232 to display the cutting completion screen 960 (see FIG. 9G) in a step S1318. As a result, the cutting completion screen 960 is displayed.

As described above, in this embodiment, the cut setting information used in the cutting by the cutting machine 300 can be generated based on the ability information of the cutting machine 300 and the print setting information in the print job, that is, based on the table 800 (see FIG. 8). This can omit the process or operation of separately generating the cut setting information independently of the print condition information. Therefore, in the image forming apparatus 100, when the print setting information is obtained, the cut setting information can be easily set. Thus, a series of operations from the start of printing to the completion of cutting can be quickly and easily performed, and the usability is improved.

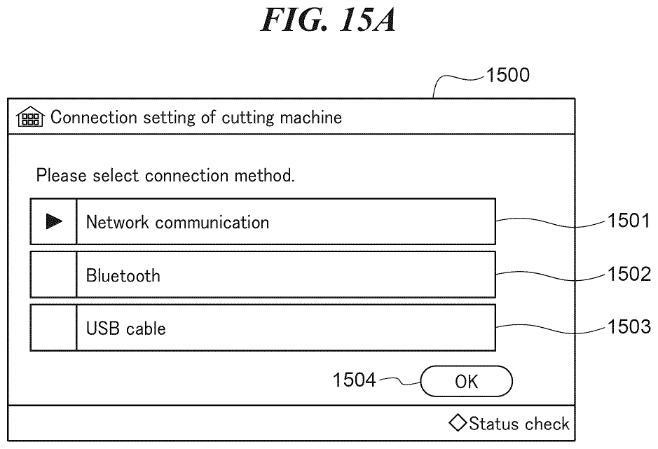

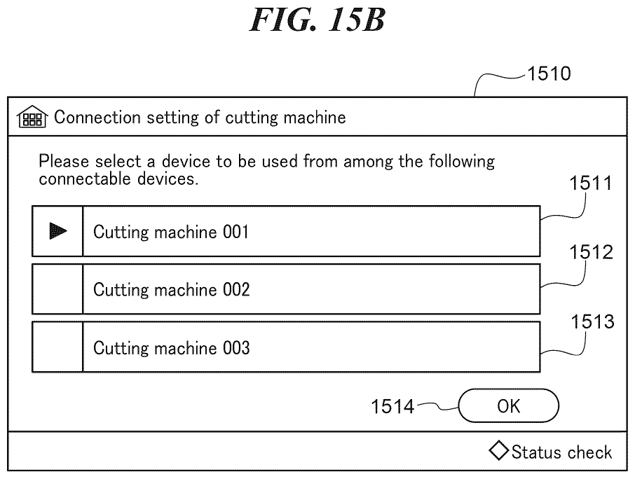

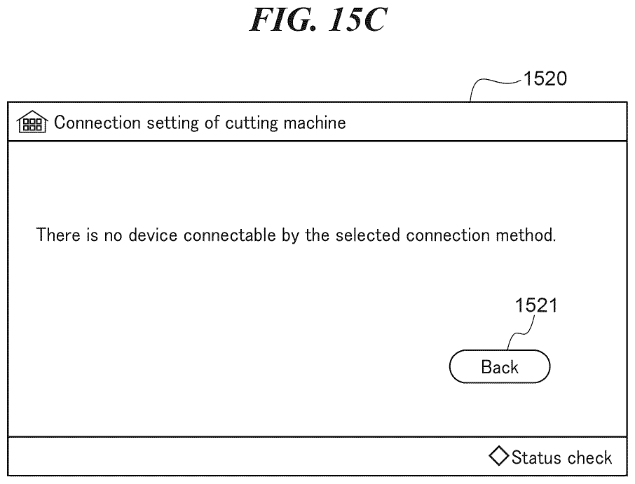

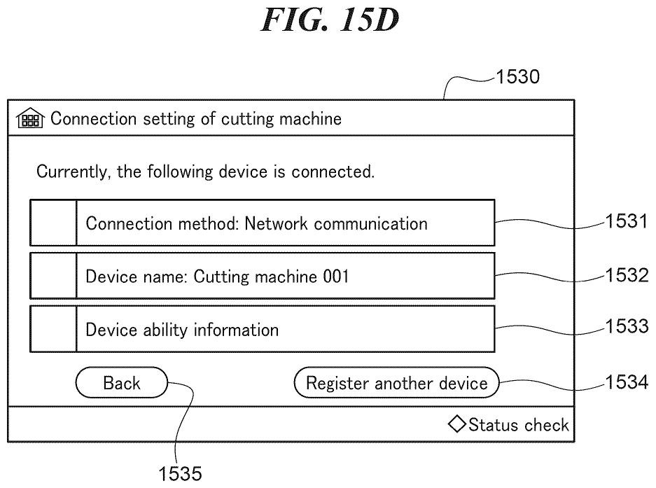

Hereinafter, a second embodiment will be described with reference to FIGS. 15A to 20B. The description will be made focusing on differences from the above-described embodiment, and the description of the same matters will be omitted. FIGS. 15A to 15D are views showing examples of operation screens in an image forming apparatus according to the second embodiment. FIG. 15A is the view showing an example of a first connection setting screen 1500 for performing a connecting operation with the cutting machine. FIG. 15B is the view showing an example of a second connection setting screen 1510 for performing the connecting operation with the cutting machine. FIG. 15C is the view showing an example of a third connection setting screen 1520 for performing the connecting operation with the cutting machine. FIG. 15D is the view showing an example of a fourth connection setting screen 1530 for performing the connecting operation with the cutting machine.

As described above, the connection between the image forming apparatus 100 and the cutting machine 300 can be set by sequentially operating the cutting machine connection setting region 911 and the OK button 914 in the application home screen 910 shown in FIG. 9B. There is a case where the information about the cutting machine 300 is not registered in the image forming apparatus 100. In this case, the displayed screen transitions to the first connection setting screen 1500 shown in FIG. 15A. The first connection setting screen 1500 includes choices 1501, 1502, and 1503, and an OK button 1504.

When the user operates the choice 1501 and the OK button 1504 in order, a network communication can be set as a connection method with the cutting machine 300, and cutting machines connectable via the network communication can be searched for. When the user operates the choice 1502 and the OK button 1504 in order, the Bluetooth (registered trademark) communication is set as the connection method with the cutting machine 300, and cutting machines connectable via the Bluetooth communication can be searched for. When the user operates the choice 1503 and the OK button 1504 in order, the USB communication is set as the connection method with the cutting machine 300, and cutting machines connectable via the USB communication can be searched for.

In this way, the first connection setting screen 1500 (selecting operation means) allows the user to select the connection method with the cutting machine 300. The connection methods with the cutting machine 300 are not limited to the method via the network communication, the method via the Bluetooth communication, and the method via the USB communication. Then, when the cutting machine 300 connectable via any of the communications is retrieved, the displayed screen transitions to the second connection setting screen 1510 shown in FIG. 15B. On the other hand, when no connectable cutting machine 300 is retrieved, the displayed screen is shifted to the third connection setting screen 1520 shown in FIG. 15C.

The second connection setting screen 1510 includes regions 1511, 1512, and 1513, and an OK button 1514. When the cutting machines connectable via any of the communications are retrieved, the image forming apparatus 100 obtains the device information, such as the device names and the ability information, from the cutting machines. This enables to display the device names in the regions 1511 to 1513. When the user operates one of the regions 1511 to 1513 and the OK button 1514 in order, the cutting machine displayed in the operated region is connected.

In this way, the second connection setting screen 1510 (selecting operation means) allows the user to select a desired cutting machine from among the three cutting machines displayed. Further, the device information is stored in the storage device 104 of the image forming apparatus 100. The device information stored in the storage device 104 may be associated with the print-cut cooperation application 210 and may be restricted from being referred to by the other applications. The third connection setting screen 1520 includes a back button 1521. When the user operates the back button 1521, the displayed screen returns to the first connection setting screen 1500. Thus, the cutting machine 300 can be connected again.

On the other hand, when the information about the cutting machine 300 is registered in the image forming apparatus 100, the displayed screen transitions to the fourth connection setting screen 1530 shown in FIG. 15D. The fourth connection setting screen 1530 includes region 1531, 1532, and 1533, a different device registration button 1534, and a back button 1535. Registered device names are displayed in the regions 1531 to 1533, respectively. Further, when the user operates the different device registration button 1534, a cutting machine different from the cutting machines displayed in the regions 1531 to 1533 can be registered. In this case, the displayed screen transitions to the first connection setting screen 1500, and the registration of the new cutting machine can be started. Further, when the user operates the back button 1535, the displayed screen transitions to the application home screen 910.

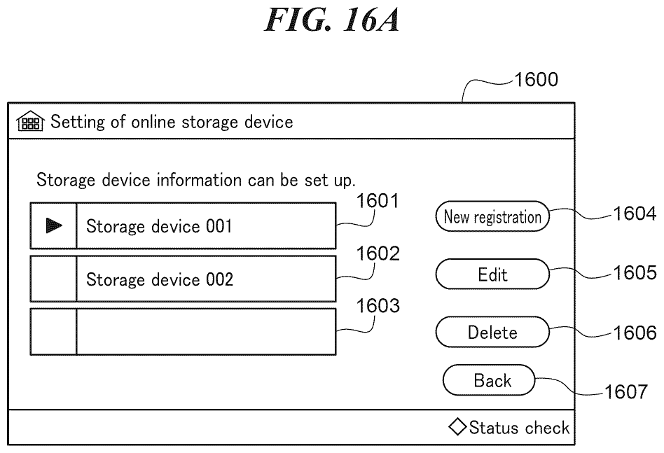

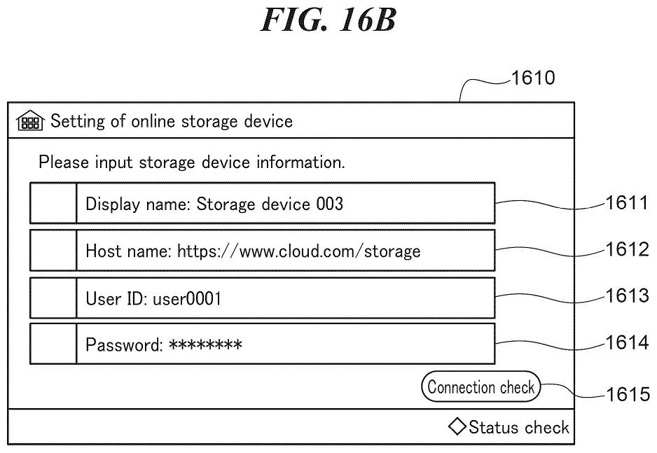

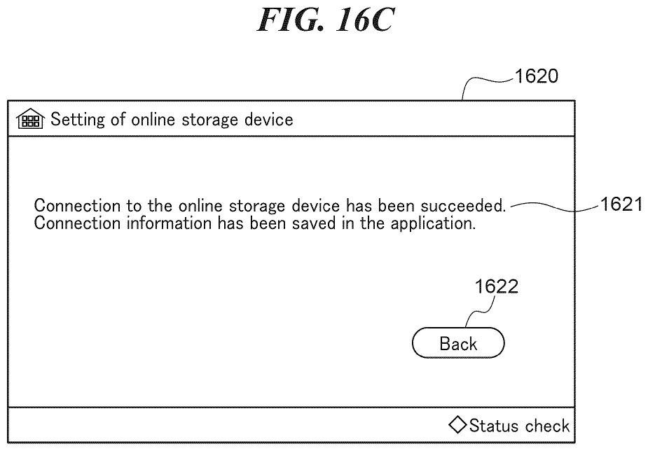

FIGS. 16A to 16C are views showing examples of operation screens of the image forming apparatus in online storage device connection setting in the print-cut cooperation application. FIG. 16A is a view showing an example of a first connection setting screen 1600 for performing a connecting operation with the storage device. FIG. 16B is a view showing an example of a second connection setting screen 1610 for performing the connecting operation with the storage device. FIG. 16C is a view showing an example of a third connection setting screen 1620 for performing the connecting operation with the storage device.

When the user sequentially operates the storage device connection setting region 912 and the OK button 914 in the application home screen 910 shown in FIG. 9B, the displayed screen transitions to the first connection setting screen 1600 shown in FIG. 16A. On the first connection setting screen 1600, a connection with the online storage device can be set. The first connection setting screen 1600 includes regions 1601, 1602, and 1603, a new registration button 1604, an edit button 1605, a deletion button 1606, and a back button 1607. The storage device names of the registered online storage devices are displayed in the regions 1601 to 1603, respectively.

When the user sequentially operates one of the regions 1601 to 1603 and the edit button 1605, the displayed screen transitions to an edit screen for editing information about the storage device displayed in the region concerned. On this edit screen, the storage device name, the authentication information, and the like can be edited. When sequentially operating one of the regions 1601 to 1603 and the deletion button 1606, the user can delete the information about the storage device displayed in the region concerned. Further, when the user operates the back button 1607, the displayed screen transitions to the application home screen 910. When the user operates the new registration button 1604, the displayed screen transitions to the second connection setting screen 1610 shown in FIG. 16B.

On the second connection setting screen 1610, the user can newly register information about a new online storage device. The second connection setting screen 1610 includes regions 1611, 1612, 1613, and 614, and a connection check button 1615. The storage device name, a host URL, a user ID, and a password are respectively displayed in the regions 1611 to 1614 in this order. The information displayed in the regions 1611 to 1614 is necessary for connecting to the online storage device.

When the user operates the connection check button 1615, the image forming apparatus 100 connects to the online storage device via the NW control module 234. After the connection to the online storage device, the displayed screen transitions to the third connection setting screen 1620 shown in FIG. 16C. The third connection setting screen 1620 includes a message area 1621 and a back button 1622. When the connection with the online storage device is successful, a message indicating the success is displayed in the message area 1621. On the contrary, when the connection with the online storage device is failed, the message indicating the failure is displayed in the message area 1621. When the user operates the back button 1622, the displayed screen returns to the first connection setting screen 1600.

Although the various settings in the print-cut cooperation application 210 are performed via the image forming apparatus 100 in this embodiment, the settings can also be performed via the communication terminal 500. Further, the cutting machine connection setting 911 and the storage device connection setting 912 may be set by accessing a web server of the image forming apparatus 100 from a web browser of the communication terminal 500. In this case, it is preferable to use a user interface function (what is called a remote UI function) for enabling the setting about the image forming apparatus 100.

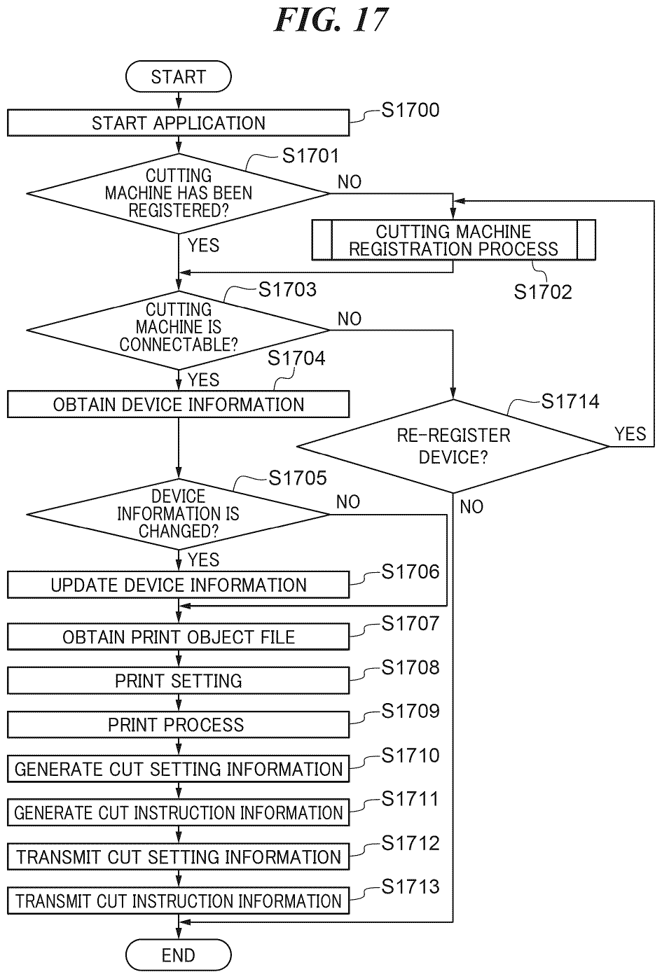

FIG. 17 is a flowchart showing an example of a process performed by the print-cut cooperation application. As shown in FIG. 17, the CPU 101 of the image forming apparatus 100 starts the print-cut cooperation application 210 in a step S1700 and proceeds with the process to a step S1701. In addition, when the print-cut cooperation application 210 is started, the application home screen 910 (see FIG. 9B) is displayed.

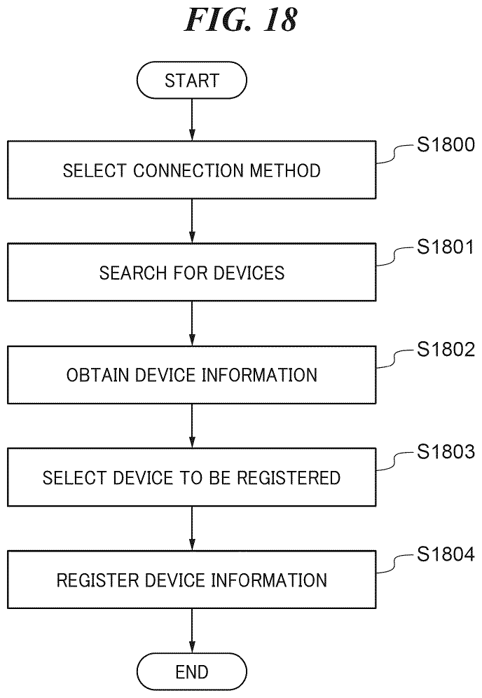

In the step S1701, the CPU 101 determines whether the cutting machine has been registered based on whether the registration information about the cutting machine 300 is stored in the ROM 103 or the storage device 104. As a result of the determination in the step S1701, when it is determined that the registration information is stored, the process proceeds to a step S1703. On the contrary, as a result of the determination in the step S1701, it is determined that the registration information is not stored, the process proceeds to a step S1702. In the step S1702, the CPU 101 performs a cutting machine registration process. The cutting machine registration process will be described later with reference to FIG. 18.

In the step S1703, the CPU 101 determines whether the cutting machine 300 is connectable. This determination is made as follows. That is, the CPU 101 controls the entire control module 220 to issue a connection request from the cutting machine control module 222 to the cutting machine 300 based on the cutting machine registration information. And then, the CPU 101 determines whether the cutting machine 300 is connectable based on whether a response to the connection request is received. Then, as a result of the determination in the step S1703, when it is determined that the cutting machine 300 is connectable, the process proceeds to a step S1704. On the contrary, as a result of the determination in the step S1703, when it is determined that the cutting machine 300 is not connectable, the process proceeds to a step S1714.

In the step S1704, the CPU 101 obtains the device information of the cutting machine 300 that was determined to be connectable in the step S1703 and proceeds with the process to a step S1705. The device information includes the ability information, and in addition, for example, information such as the device name of the cutting machine 300, sheet types and sheet sizes that are supported by the cutting machine 300.

In the step S1705, the CPU 101 compares the device information obtained in the step S1704 with the device information registered with the image forming apparatus 100 to determine whether the registered device information is changed. The device information is referred to when the cut setting information is generated. Then, as a result of the determination in the step S1705, when it is determined that the registered device information is changed, the process proceeds to a step S1706. On the contrary, when it is determined in the step S1705 that the registered device information is not changed, the process proceeds to a step S1707.

In the step S1706, the CPU 101 performs an update process to update the device information and proceeds with the process to the step S1707. The process in the step S1705 may be omitted. In this case, the update process of the device information in the step S1706 is executed regardless of whether the device information is updated.

In the step S1707, the CPU 101 obtains the print data file (print object file) from the external storage device and proceeds with the process to a step S1708. The print data file can be obtained by selecting any of the file name regions 931 to 933 in the file selection screen 930 (see FIG. 9D).

In the step S1708, the CPU 101 obtains the print setting items (print condition) in printing the print data file obtained in the step S1707, and proceeds with the process to a step S1709. The print setting items are set values set in the sheet size field 941 to the cutting mark setting field 944 in the print setting screen 940 (see FIG. 9E), and these set values are obtained.

In the step S1709, the CPU 101 performs printing of the print data file under the print setting obtained in the step S1708, and proceeds with the process to a step S1710. The print data file is printed by processing the image data included in the printing data file by the printer image processor 190 and controlling the printer 195 by the job control module 231 to transfer ink or toner to a sheet. In addition, when the cutting mark setting field 944 in the print setting screen 940 is set to “ON”, the image data obtained by the image generation module 224 combining the cutting mark information regarding the cutting mark generated by the cutting mark generation module 223 and the image data of the print data file is printed.

In the step S1710, the CPU 101 generates the cut setting information for the cutting machine 300 by controlling the cut setting information generation module 221 via the entire control module 220. The cut setting information is generated based on the table 800 (see FIG. 8). After the cut setting information is generated, the process proceeds to a step S1711. In the step S1711, the CPU 101 generates the cut instruction information 1400 (see FIG. 14) by controlling the cut setting information generation module 221 via the entire control module 220. Specifically, the cut setting information generation module 221 extracts a cut area to be a cut line from the image data of the print data file, and then generates the cut instruction information using two dimensional coordinate data of the cut area that is converted so that the position of the cutting mark becomes an origin. After the cut instruction information 1400 is generated, the process proceeds to a step S1712.

In the step S1712, the CPU 101 controls the NW control module 234 to transmit the cut setting information generated in the step S1710 to the cutting machine 300. After the cut setting information is transmitted, the process proceeds to a step S1713.

In the step S1713, the CPU 101 controls the NW control module 234 to transmit the cut instruction information 1400 generated in the step S1711 to the cutting machine 300. After the cut instruction information 1400 is transmitted, the process is terminated.

In the step S1714 after the step S1703 is performed, the CPU 101 displays a screen prompting the user to re-register the cutting machine 300 and determines whether to re-register on the screen. As a result of the determination in the step S1714, when it is determined that the user instructs to re-register, the process proceeds to the step S1702. On the contrary, as a result of the determination in the step S1714, when it is determined that the user does not instruct to re-register, the process ends.

FIG. 18 is a flowchart showing the cutting machine registration process (subroutine) in the step S1702 in the flowchart shown in FIG. 17. As shown in FIG. 18, in a step S1800, the CPU 101 of the image forming apparatus 100 obtains information about the selection result of the connection method with the cutting machine 300. The connection method with the cutting machine 300 can be selected on the first connection setting screen 1500 (see FIG. 15A). Then, the CPU 101 obtains the selection result. After the execution of the step S1800, the process proceeds to a step S1801.

In the step S1801, the CPU 101 searches for all devices that are connectable with the connection method selected in the step S1800. All the devices may include a device other than a cutting machine in addition to the cutting machine 300. The CPU 101 obtains the identification information of each device, determines whether the device is a cutting machine based on the identification information, and searches for cutting machines only. After the execution of the step S1801, the process proceeds to a step S1802.

In the step S1802, the CPU 101 obtains the device information about the cutting machine(s) retrieved in the step S1801. When a plurality of cutting machines are retrieved in the step S1801, the CPU 101 obtains the pieces of device information about the respective cutting machines. After the execution of the step S1802, the process proceeds to a step S1803.

In the step S1803, the CPU 101 obtains information regarding the result of selecting the cutting machine 300 registered in the image forming apparatus 100. The cutting machine 300 can be selected on the second connection setting screen 1510 (see FIG. 15B). Then, the CPU 101 obtains the selection result. After the execution of the step S1803, the process proceeds to a step S1804.

In the step S1804, the CPU 101 registers the cutting machine 300 selected in the step S1803. As this registration method, for example, there is a method of storing connection setting information for connecting the cutting machine 300 in the storage device 104 of the image forming apparatus. The connection setting information includes information, such as the connection method and the device information. After the execution of the step S1804, the process is terminated.

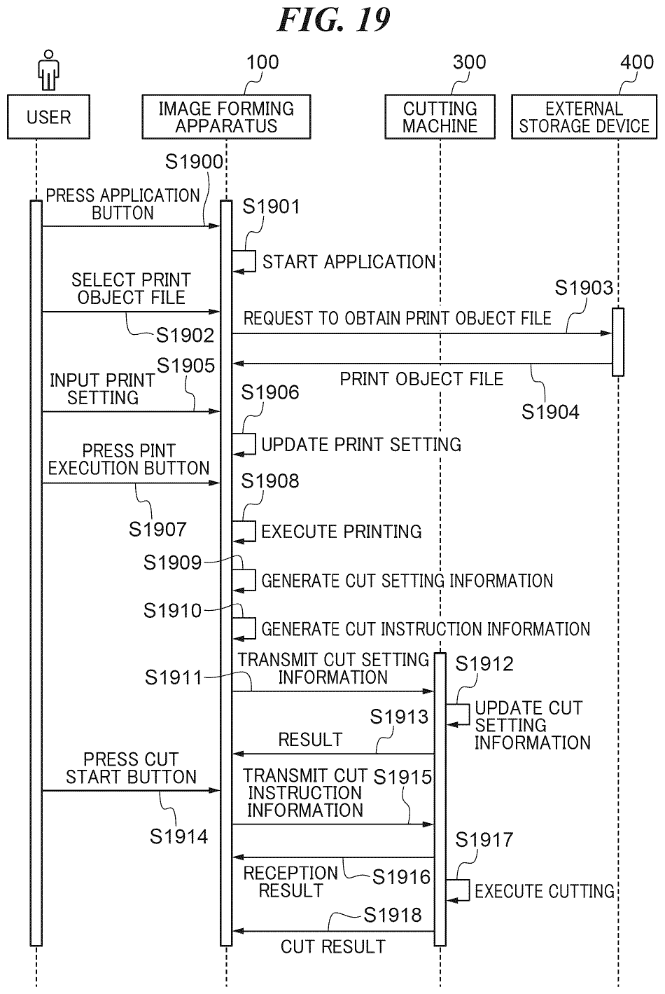

FIG. 19 is a sequential chart showing an example of a process performed between the user, the image forming apparatus 100, the cutting machine 300, and an external storage device 400. As shown in FIG. 19, in a step S1900, the user operates the cutting icon 903, which is one of the application buttons in the home screen 900 (see FIG. 9A).

At step S1901, image forming apparatus 100 starts the print-cut cooperation application 210. By this starting, the application home screen 910 (see FIG. 9B) is displayed.

In a step S1902, the user selects a file name region indicating a desired file (print job) to be the print object file from among the file name regions 931 to 933 in the file selection screen 930 (see FIG. 9D). Although the file name regions 931 to 933 indicate the files set by the print driver 1001 in the first embodiment, the file name regions 931 to 933 indicate the files set by operating the operation unit 112 (setting means) of the image forming apparatus 100 in this embodiment. The files indicated by the file name regions 931 to 933 are stored in the external storage device 400. In this case, the files indicated in the file name regions 931 to 933 may be stored in the same external storage device 400 or may be stored in different external storage devices. Further, the files indicated in the file name regions 931 to 933 are not limited to be stored in the external storage device 400, and may be stored in the storage device 104 of the image forming apparatus 100.

In a step S1903, the image forming apparatus 100 accesses the external storage device 400 that stores the print object file selected in the step S1902. Then, the image forming apparatus 100 requests the external storage device 400 to obtain the print data file.

In a step S1904, the image forming apparatus 100 obtains the print object file by the job control module 231 (job obtaining means) from the external storage device 400. Although the obtaining source of the print object file (print job) is the print driver of the communication terminal 500 in the first embodiment, the obtaining source is the external storage device 400 storing the print object file set through the operation unit 112 in this embodiment.

In a step S1905, the user operates the print setting screen 940 (see FIG. 9E) to input the print setting. In a step S1906, the image forming apparatus 100 updates the print setting based on the print setting input in the step S1905. In a step S1907, the user operates the print start button 945 in the print setting screen 940.

In a step S1908, the image forming apparatus 100 performs the print process (the step S1709). Thus, the print object file is printed. In a step S1909, the image forming apparatus 100 generates the cut setting information. In step S1910, the image forming apparatus 100 generates the cut instruction information.

In a step S1911, the image forming apparatus 100 transmits the cut setting information generated in the step S1909 to the cutting machine 300.

In a step S1912, the cutting machine 300 updates the cut setting information in the cut condition setting module 405 based on the cut setting information transmitted in the step S1911. In a step S1913, the cutting machine 300 transmits the update result in the step S1912 to the image forming apparatus 100.

In a step S1914, the user operates the cut start button 951 in the cutting preparation screen 950 (see FIG. 9F).

In a step S1915, the image forming apparatus 100 transmits the cut instruction information generated in the step S1909 to the cutting machine 300.

When receiving the cut instruction information transmitted in the step S1915, the cutting machine 300 transmits the reception result to the image forming apparatus 100 in a step S1916.

In step S1917, the cutting machine 300 executes the cut process based on the cut instruction information received in the step S1916 by the cut process execution module 406.

When the execution of the cut process in the step S1917 is completely finished or when an error occurs during the execution of the cut process, the cutting machine 300 transmits the fact to the image forming apparatus 100 as a cut result in a step S1918.

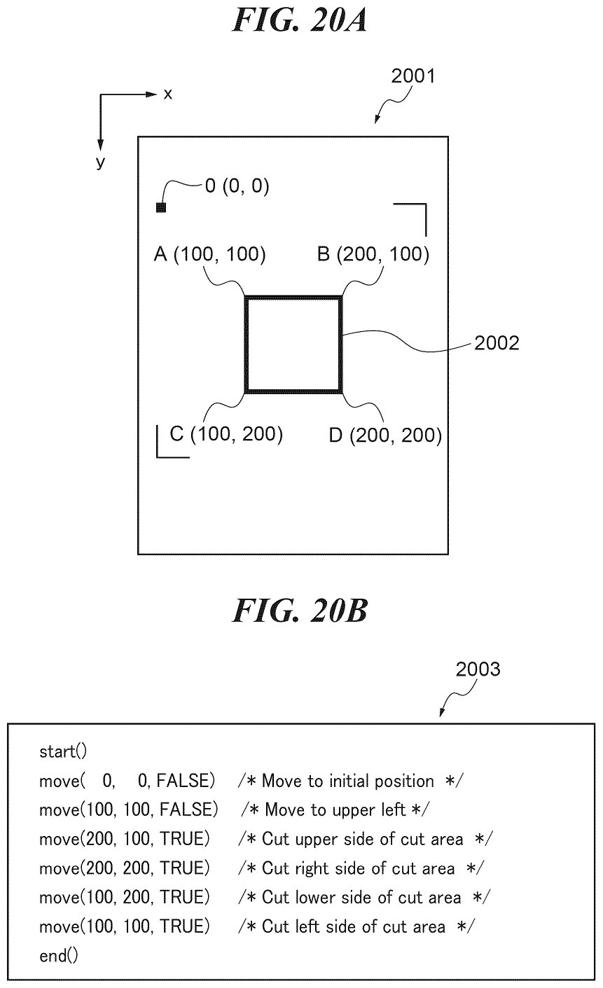

FIG. 20A and FIG. 20B show an example of the cut instruction information. FIG. 20A is a view showing coordinates of corners of a cut line relative to printed matter. FIG. 20B shows the cut instruction information generated by the cut setting information generation module. As shown in FIG. 20A, the cut line 2002 is printed on the printed matter 2001. The cut line 2002 shows a portion cut by the cutting machine 300. The cut setting information generation module 221 of the image forming apparatus 100 converts the cut line 2002 into the two dimensional coordinate information in which the cutting mark position O is the origin, and generates the cut instruction information 2003 shown in FIG. 20B. The cut instruction information 2003 is generated in the step S1910. The cut instruction information 2003 includes the coordinates of the cut area and the like.

As described above, even in this embodiment, the image forming apparatus 100 can generate the cut setting information based on the table 800 (see the step S1710). This enables easy setting of the cut setting information, and thus a series of operations from the start of printing to the completion of cutting can be executed quickly and easily.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-176843, filed Oct. 12, 2023, which is hereby incorporated by reference herein in its entirety.

What is claimed is:

1. An information processing apparatus communicably connected to a cutting machine that cuts a sheet medium printed and processing information transmitted and received to and from the cutting machine, the information processing apparatus comprising:
a memory device that stores a set of instructions; and
at least one processor that executes the set of instructions to:
obtain ability information about cutting ability of the cutting machine from the cutting machine;
obtain a print job including print condition information about a print condition; and
generate cut condition information related to a cut condition in cutting the sheet medium with the cutting machine based on the ability information obtained and the print condition information included in the print job obtained,
wherein the sheet medium is cut by the cutting machine based on the cut condition information generated.

2. The information processing apparatus according to claim 1, wherein the information processing apparatus is communicatively connected to an apparatus storing a print driver, and
wherein the at least one processor executes instructions in the memory device to obtains the print job from the print driver.

3. The information processing apparatus according to claim 1, further comprising a setting unit configured to set the print job,
wherein the at least one processor executes instructions in the memory device to obtain the print job from the setting unit.

4. The information processing apparatus according to claim 1, wherein the at least one processor executes instructions in the memory device to allow a user to select whether to cut the sheet medium by the cutting machine.

5. The information processing apparatus according to claim 4, wherein a plurality of cutting machines are communicatively connected to the information processing apparatus, and
wherein the at least one processor executes instructions in the memory device to allow the user to select a desired cutting machine from among the plurality of cutting machines.

6. The information processing apparatus according to claim 4, wherein the at least one processor executes instructions in the memory device to allow the user to select a connection method with the cutting machine.

7. The information processing apparatus according to claim 4, wherein the at least one processor executes instructions in the memory device to enable an operation by the user to instruct obtaining the ability information in a case where the user selects to cut the sheet medium by the cutting machine.

8. The information processing apparatus according to claim 7, wherein the at least one processor executes instructions in the memory device to enable an operation by the user to instruct obtaining the print job in a case where the user operates to instruct obtaining the ability information.

9. The information processing apparatus according to claim 8, wherein the at least one processor executes instructions in the memory device to enable an operation by the user to instruct transmitting the cut condition information in a case where the user operates to instruct obtaining the print job.

10. The information processing apparatus according to claim 9, wherein the at least one processor executes instructions in the memory device to enable an operation by the user to instruct cutting the sheet medium by the cutting machine in a case where the user operate to instruct transmitting the cut condition information.

11. The information processing apparatus according to claim 1, wherein the at least one processor executes instructions in the memory device to generate, as the cut condition information, at least one of parameters including a force pressing a cutting blade against the sheet medium in cutting, a cut speed in cutting the sheet medium, and number of times of cutting on one place in cutting the sheet medium.

12. The information processing apparatus according to claim 11, wherein the print condition information includes a type of the sheet medium to be printed, and
wherein the at least one processor executes instructions in the memory device to generate information about the parameter corresponding to the type of the sheet medium as the cut condition information.

13. The information processing apparatus according to claim 1, wherein the at least one processor executes instructions in the memory device to transmit the cut condition information to the cutting machine.

14. The information processing apparatus according to claim 13, further comprising a memory unit configured to store the cut condition information,
wherein the at least one processor executes instructions in the memory device to be capable of transmitting the cut condition information stored in the memory unit to the cutting machine after printing.

15. The information processing apparatus according to claim 1, further comprising a display unit configured to display a preview image showing a sample of a cutting area on the sheet medium.

16. The information processing apparatus according to claim 1, wherein the information processing apparatus comprises an image forming apparatus that is capable of printing.

17. An information processing system comprising:
a cutting machine configured to cut a sheet medium printed; and
an information processing apparatus communicably connected to the cutting machine and processing information transmitted to and received from the cutting machine, the information processing apparatus comprising:
a memory device that stores a set of instructions; and
at least one processor that executes the set of instructions to:
obtain ability information about cutting ability of the cutting machine from the cutting machine;
obtain a print job including print condition information about a print condition; and
generate cut condition information related to a cut condition in cutting the sheet medium with the cutting machine based on the ability information obtained and the print condition information included in the print job obtained,
wherein the sheet medium is cut by the cutting machine based on the cut condition information generated.

18. A control method for an information processing apparatus communicably connected to a cutting machine that cuts a sheet medium printed and processing information transmitted and received to and from the cutting machine, the control method comprising:
obtaining ability information about cutting ability of the cutting machine from the cutting machine;
obtaining a print job including print condition information about a print condition; and
generating cut condition information related to a cut condition in cutting the sheet medium with the cutting machine based on the ability information obtained and the print condition information included in the print job obtained,
wherein the sheet medium is cut by the cutting machine based on the cut condition information generated.

19. A non-transitory computer-readable storage medium storing a control program causing a computer to execute a control method for an information processing apparatus communicably connected to a cutting machine that cuts a sheet medium printed and processing information transmitted and received to and from the cutting machine, the control method comprising:
obtaining ability information about cutting ability of the cutting machine from the cutting machine;
obtaining a print job including print condition information about a print condition; and
generating cut condition information related to a cut condition in cutting the sheet medium with the cutting machine based on the ability information obtained and the print condition information included in the print job obtained,
wherein the sheet medium is cut by the cutting machine based on the cut condition information generated.
